(19) United States
(12) Patent Application Publication
(10) Pub. No.: US 2005/0223023 A1
(43) Pub. Date: Oct. 6, 2005

(54) Generating pages suitable for viewing over the internet

(75) Inventor: Timothy Bispham King, Rotherham (GB)

Correspondence Address: RICHARD M. GOLDBERG, 25 EAST SALEM STREET, SUITE 419, HACKENSACK, NJ, 07601, US

(73) Assignee: Duty Crew Limited, Rotherham (GB)

(21) Appl. No.: 11/091,847

(22) Filed: Mar. 28, 2005

(30) Foreign Application Priority Data
Apr. 1, 2004 (GB) 04 07 420.9

(51) Int. Cl. G06F 17/00; G06F 17/30

(52) U.S. Cl. 707/102; 707/2

(57) ABSTRACT

A method is provided of generating a plurality of pages suitable for viewing over the Internet with hyperlinks interconnecting said pages, wherein each page includes a plurality of hyperlinks arranged to represent a portion of a hierarchical navigation system. The method comprises the steps of storing a plurality of content files for containing content data, creating and storing a logical and editable representation of said navigation structure in the form of navigation data; and processing said content files in combination with said navigation data to produce a plurality of pages each representing said navigation structure, such that when displayed by a browser a content area derived from said content data is displayed with components of said navigation structure within the boundary of a viewable page.

### BACKGROUND OF THE INVENTION

1. Field of the Invention

The invention relates to the generation of pages that are suitable for viewing over the Internet.

2. Description of the Related Art

Pages suitable for viewing over the Internet, known generally as webpages, are usually written in a markup language such as HTML (HyperText Markup Language). They contain clickable links to other pages, known as hyperlinks, either within the same website or on another site. When a user clicks on a hyperlink the page indicated by the hyperlink is opened. In a static webpage these hyperlinks must be hardcoded in, which does not facilitate making changes to a website once the design process has started.

It is possible to use frames to set out a navigation structure for a page, such that a viewable page is actually composed of one or more frames, each of which is actually a page in itself. One of these contains the content of the page and the other contains the navigation structure. This means that to change the navigation structure only one webpage needs to be changed. However, frames pose several problems, for example that search engines tend to pick up only one of the frames, a browser often bookmarks only one of the frames, and “back” and “forward” navigation becomes difficult. Frames are therefore not a good solution for a user-friendly website.

Dynamic webpages can be created. These consist mainly of code of some kind, for example a scripting language, that creates a page “on-the-fly”. This is suitable, for example, for on-line shopping websites, search engines, email providers and websites containing a lot of advertising. However, dynamic websites are usually slower than static ones and thus it is better to use dynamic content only where required, for example for prices of goods, and not for the navigation links. In particular, if no dynamic content is required at all, static webpages are considered to be better.

### BRIEF SUMMARY OF THE INVENTION

According to a first aspect of the invention, there is provided a method of generating a plurality of pages suitable for viewing over the Internet with hyperlinks interconnecting said pages, wherein each page includes a plurality of hyperlinks arranged to represent a portion of a hierarchical navigation system. The method comprises the steps of storing a plurality of content files for containing content data, creating and storing a logical and editable representation of said navigation structure in the form of navigation data; and processing said content files in combination with said navigation data to produce a plurality of pages each representing said navigation structure, such that when displayed by a browser a content area derived from said content data is displayed with components of said navigation structure within the boundary of a viewable page.

### BRIEF DESCRIPTION OF THE SEVERAL VIEWS OF THE DRAWINGS

FIG. 1 illustrates an Internet environment;

FIG. 2 illustrates a web design terminal shown in FIG. 1;

FIG. 3 details a computer system shown in FIG. 2;

FIG. 4 shows steps carried out to create a website at the terminal shown in FIG. 2;

FIG. 5 details steps carried out during FIG. 4 at which a web design application is loaded;

FIG. 6 shows the contents of the memory shown in FIG. 3 during the steps shown in FIG. 4;

FIG. 7 shows an HTML page;

FIG. 8 illustrates the viewable page that is created by a browser using the HTML page shown in FIG. 7;

FIG. 9 shows a database shown in FIG. 6;

FIG. 10 illustrates an example of a navigation structure;

FIG. 11 details steps carried out during FIG. 4 at which a website design is edited;

FIG. 12 details steps carried out during FIG. 11 at which the user may create and edit categories;

FIG. 13 details steps carried out during FIG. 11 at which the user creates and edits menu items;

FIG. 14 details steps carried out during FIG. 11 at which the user may create and edit pages;

FIG. 15 details steps carried out during FIG. 12 to create categories;

FIG. 16 illustrates a category-creation webpage;

FIG. 17 details steps carried out during FIG. 12 to reorder categories;

FIG. 18 details steps carried out during FIG. 13 to create menu items;

FIG. 19 details steps carried out during FIG. 18 to display a viewable webpage;

FIG. 20 details steps carried out during FIG. 19 to create a category string;

FIG. 21 shows an example of the category string created during FIG. 20;

FIG. 22 details steps carried out during FIG. 19 to create a dependents list;

FIG. 23 details steps carried out during FIG. 19 to populate a table;

FIG. 24 details steps carried out during FIG. 23 to insert an “INVALID” row in the table;

FIG. 25 details steps carried out during FIG. 23 to insert a “MOVEMENT” row for an identified menu item;

FIG. 26 details steps carried out during FIG. 25 to create a button moving a selected menu item to be the elder sibling of an identified menu item;

FIG. 27 details steps carried out during FIG. 25 to create a button that moves a selected menu item to be a child of an identified menu item;

FIG. 28 details steps carried out during FIG. 23 to create a “MOVEMENT” row for a selected menu item;

FIG. 29 details steps carried out during FIG. 28 to create a button that moves a selected menu item to an indicated position;

FIG. 30 illustrates a viewable webpage to move menu items;

FIG. 31 details steps carried out during FIG. 14 to create a page;

FIG. 32 details steps carried out during FIG. 31 to save a page;

FIG. 33 details steps carried out during FIG. 31 to place a page;

FIG. 34 details steps carried out during FIG. 33 to display a page-ordering webpage;

FIG. 35 illustrates a viewable webpage created during FIG. 34;

FIG. 36 details steps carried out during FIG. 14 to edit a page;

FIG. 37 details steps carried our during FIG. 36 to edit content data in a page;

FIG. 38 details steps carried out during FIG. 4 to create a website;

FIG. 39 details steps carried out during FIG. 38 to prepare a destination directory;

FIG. 40 details carried out during FIG. 38 to create a page sequence string;

FIG. 41 details steps carried out during FIG. 40 to populate a first category array;

FIG. 42 details steps carried out during FIG. 40 to populate a second category array;

FIG. 43 details steps carried out during FIG. 42 to identify completed rows;

FIG. 44 details steps carried out during out FIG. 38 to generate a page;

FIG. 45 details steps carried out during FIG. 44 to create a navigation structure;

FIG. 46 details steps carried out during FIG. 45 to set a variable THISMENUID;

FIG. 47 details steps carried out during FIG. 42 to identify names for identified IDs;

FIG. 48 details steps carried out during FIG. 45 to publish a page;

FIG. 49 details carried out during FIG. 48 to insert code defining a content area;

FIG. 50 details steps carried out during FIG. 49 to insert code for category hyperlinks;

FIG. 51 details steps carried out during FIG. 49 to create hyperlinks for visible menu items;

FIG. 52 details steps carried out during FIG. 51 to insert code for a hyperlink;

FIG. 53 details steps carried out during FIG. 49 to enter content data into a page;

FIG. 54 details steps carried out during FIG. 44 to save a page; and

FIG. 55 illustrates an example of a page created during FIG. 44.

### WRITTEN DESCRIPTION OF THE BEST MODE FOR CARRYING OUT THE INVENTION

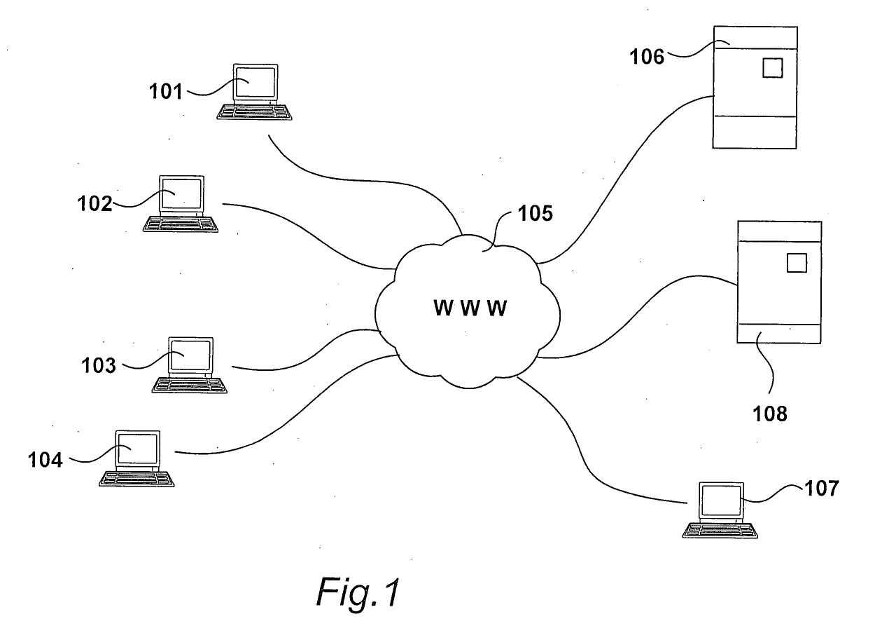

FIG. 1

An internet environment is illustrated in FIG. 1. Terminals 101, 102, 103 and 104 are connected to the Internet 105. Each of these terminals comprises a programmable computer system that includes an internet connection, such as a modem, and has an internet browser installed upon it. Using this connection each terminal can access viewable pages stored on a host server, such as host server 106. These pages are written in a markup language, which in this example is the HyperText Markup Language (HTML), which a browser processes and displays to the user of a terminal. Each of these terminals may be any kind of computer, running any version of any brand of browser.

Web design terminal 107 is also connected to the internet and may browse pages using its installed browser. However, it also has a website design application provided by server 108 which allows the user of terminal 107 to create pages. These pages are uploaded to host server 106 and are thereby available for viewing by any of terminals 101 to 104.

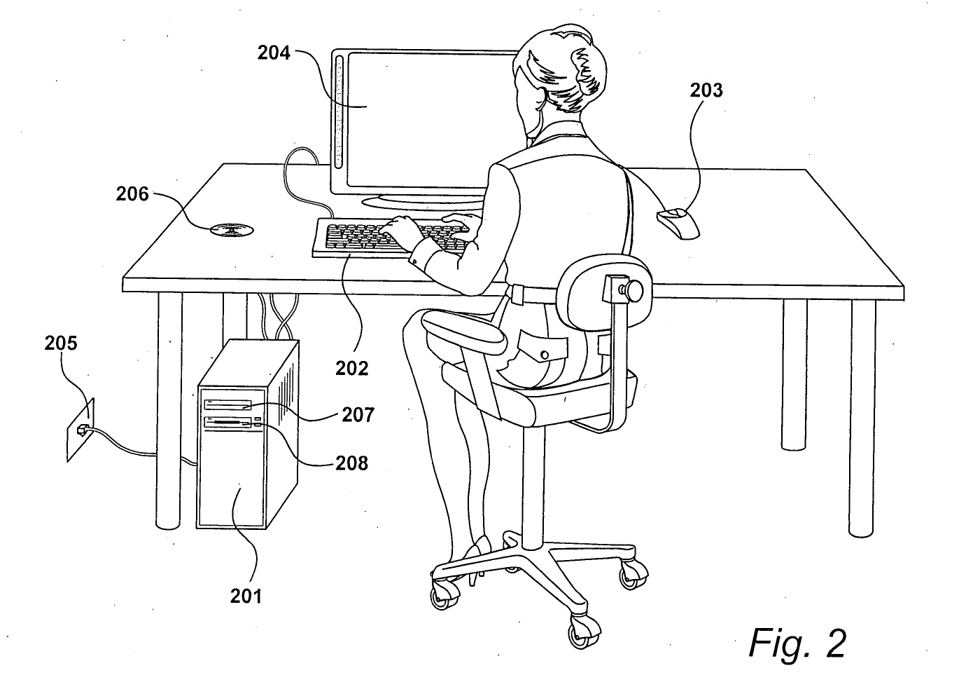

FIG. 2

Apparatus for publishing a website is provided in this example by web design terminal 107, which is illustrated in FIG. 2. Data processing is effected by a programmable computer 201 that responds to input data from a user via a keyboard 202, and a mouse 203, or similar manual input devices. Output data from computer system 201 is displayed to the user via a display, such as visual display unit (VDU) 204. An internet connection 205 allows the computer 201 to communicate with the internet.

Computer 201 receives input data from the keyboard 202 and other input devices via cable connections although in alternative embodiments radio interfaces could be provided. Many different types of programmable computer 201 could be deployed and in alternative embodiments the functionality could be provided using dedicated hardware.

Instructions executable by computer system 201 are installed via an computer-readable medium such as a CD-ROM 206 or a similar instruction-carrying medium such as a DVD etc. They may also be installed via internet connection 205. The computer 201 may also have devices for recording output data, such as CD-ROM burners or DVD burner 207 or removable magnetic disk storage device 208, for example.

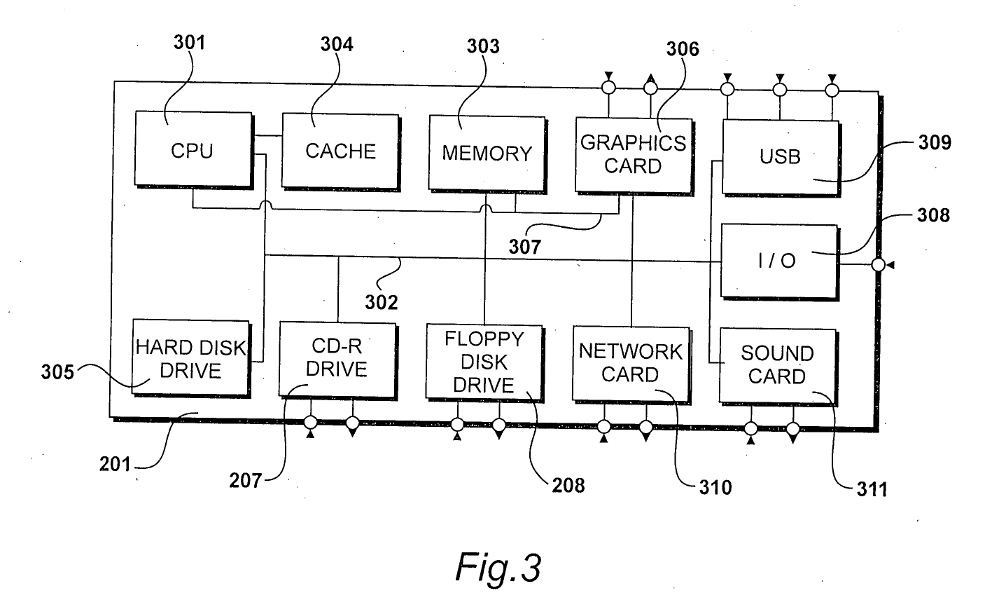

FIG. 3

The components of computer system 201 are further detailed in FIG. 3. The system includes a processor, provided in this embodiment by a Pentium 4™ central processing unit (CPU) 301 which fetches and executes instructions and manipulates data via a system bus 302, providing connectivity with a larger main memory 303, CD-ROM re-writer 108, removable magnetic disk drive 109 and other components which will be further detailed below. System bus 302 is, for instance, a crossbar switch or other such bus connectivity logic. CPU 301 is configured with a high-speed cache 304 comprising between two hundred and fifty-six and five hundred and twelve kilobytes, which stores frequently-accessed instructions and data to reduce fetching operations from larger memory 303. Memory 303 comprises between two hundred and fifty-six megabytes and one gigabyte of dynamic randomly accessible memory and stores executable programs which, along with data, are received via said bus 302 from a hard disk drive 305. Hard disk drive (HDD) 305 provides non-volatile bulk storage of instructions and data.

A graphics card 306 receives graphics data from the CPU 301, along with graphics instructions. Said graphics accelerator 306 is preferably coupled to the CPU 301 by means of a direct port 307, such as the advanced graphics port (AGP) promulgated by the Intel Corporation, the bandwidth of which exceeds the bandwidth of bus 302. Preferably, the graphics card 306 includes substantial dedicated graphical processing capabilities, so that the CPU 301 is not burdened with computationally intensive tasks for which it is not optimised.

Input/output interface 308 provides standard connectivity to peripherals such as keyboard 102 and mouse 103. A Universal Serial Bus (USB) 309 is provided as an alternative means of providing connectivity to these peripherals, whereby said connectivity is improved with a faster bandwidth for user input data transfer.

Network card 310 provides connectivity to the Internet 105 by processing a plurality of communication protocols. A sound card 311 is provided which receives sound data from the CPU 301 over system bus 302 along with sound processing instructions, in a manner similar to graphics card 306. Preferably, the sound card 311 includes substantial dedicated digital sound processing capabilities, so that the CPU 301 is not burdened with computationally intensive tasks for which it is not optimised.

The equipment shown in FIG. 3 constitutes an inexpensive programmable computer of fairly standard type, such as a programmable computer known to those skilled in the art as an IBM® PC compatible or an Apple® Mac®. However, any programmable computer may be used since the application described herein is designed to be non-platform specific.

User terminals 101 to 104 are similar but again can be any kind of programmable computer.

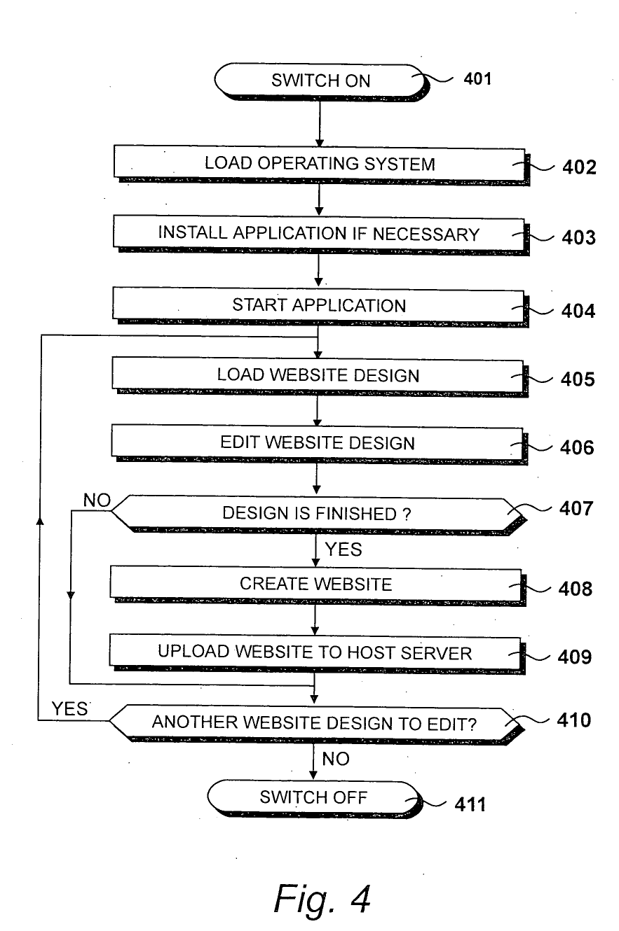

FIG. 4

FIG. 4 shows steps carried out at web design terminal 107 to create a website. At step 401 computer system 201 is switched on and at step 402 the operating system is loaded. The operating system may be, for example, Microsoft® Windows®, Mace OS X or Linux®, since the web design application described herein is non-platform specific.

At step 402 the application is installed, if necessary, either by downloading the instructions via the Internet 105 from server 108 or by installing them from CD-ROM 206. This installation process includes installing, if necessary, instructions for a web server and a database application, and copying a parser library and application files onto hard disk drive 305.

At step 403 the application is started and at step 405 a website design is loaded. This may be a design that has been started or a default empty design that has yet to have any content added. At step 406 the user of web design terminal 107 edits the website design.

At step 407 a question is asked as to whether the design is finished. If this question is answered in the affirmative then at step 408 the website itself is created and uploaded to host server 106 at step 409. Following this, and if the question asked at step 407 is answered in the negative, a further question is asked as to whether there is another website design to edit. If this question is answered in the affirmative then control is returned to step 405 and another website design is loaded. If it is answered in the negative then the computer system 201 is switched off at step 411.

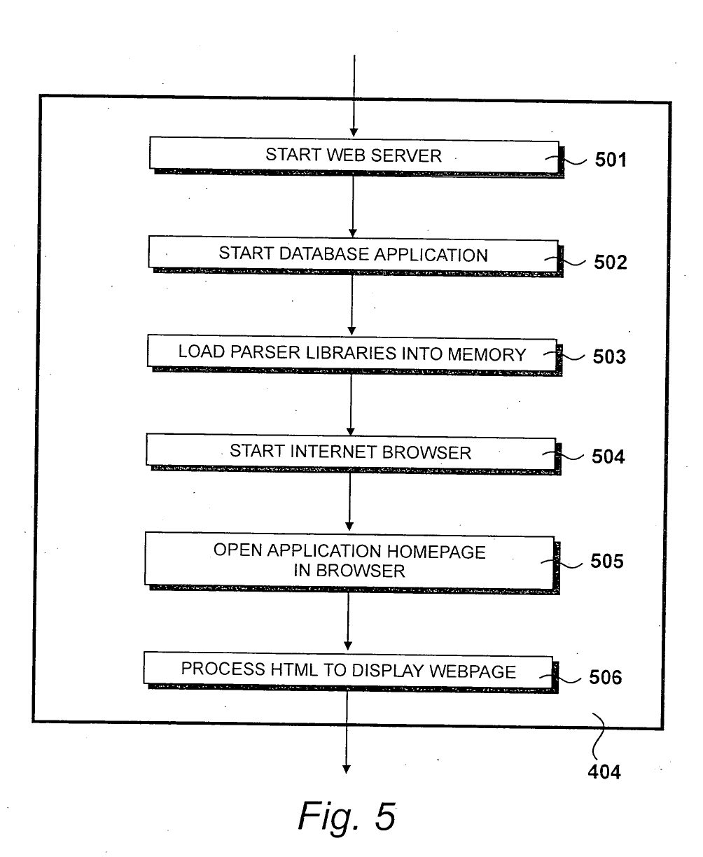

FIG. 5

FIG. 5 details step 404 at which the web design application is loaded. At step 501 the web server installed at step 403 is started and at step 502 the database application is started. In this embodiment the web server used is Apache® and the database application is MySQL®. These are used because they are not platform-specific, but other web servers and database applications could be used.

At step 503 the parser libraries are loaded into memory. These are to enable a scripting language that the scripts in the application are written in. In this embodiment the language is PHP (PHP Hypertext Preprocessor), again because it is cross-platform, although other languages could be used.

At step 504 the internet browser is started. The browser used is often dependent upon the operating system, and popular browsers are Microsoft® Internet Explorer@, Apple® Safari®, Netscape® and the open-source Mozilla®. However, any browser, even those that are not W3C compliant, may be used.

At step 505 the browser opens the application homepage. This is a webpage that was copied to the hard disk drive 105 during the installation process 403 and this step comprises the browser requesting the operating system to load the page into memory. At step 506 the browser processes the code contained in the page, which in this embodiment is HTML with embedded PHP, to display the page to the user on VDU 104.

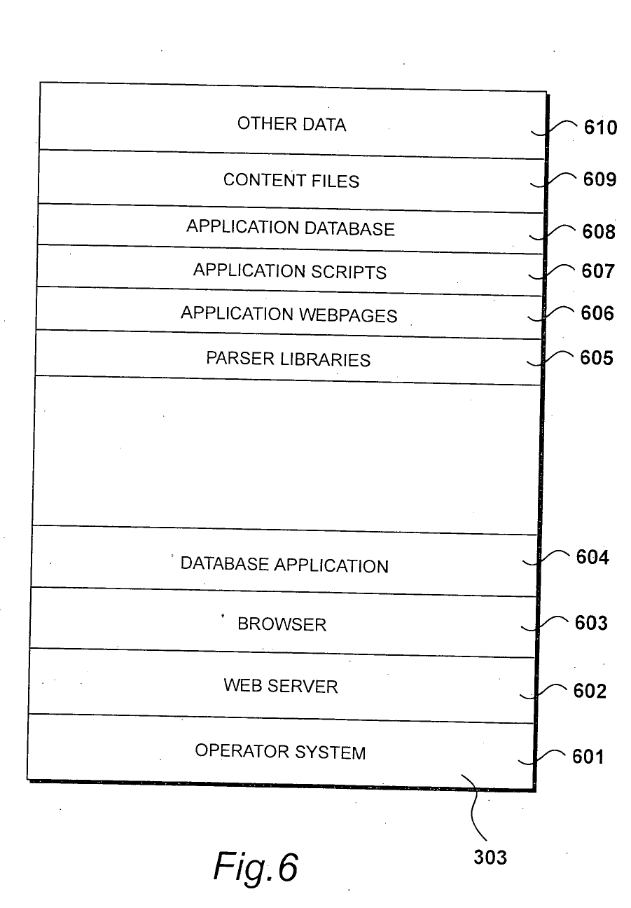

FIG. 6

FIG. 6 shows the contents of memory 303 following the loading of the web design application at step 404. The operating system 601 provides operating system instructions for common system tasks and device abstraction. Web server 602 provides a structure to execute the scripting language PHP and web browser 603 processes HTML in order to display web pages to a user. Database application 604 is used to store data needed for the web design application.

Parser libraries 605 provide a framework for PHP. Application webpages 606, written in HTML with embedded PHP, provide an interface for the web design application and application scripts 607, written in PHP, provide certain functions to the application. Application database 608 contains navigation and style data for the website designs and content files 609 provide content data. Other data 610 includes temporary data structures used by applications 601 to 604.

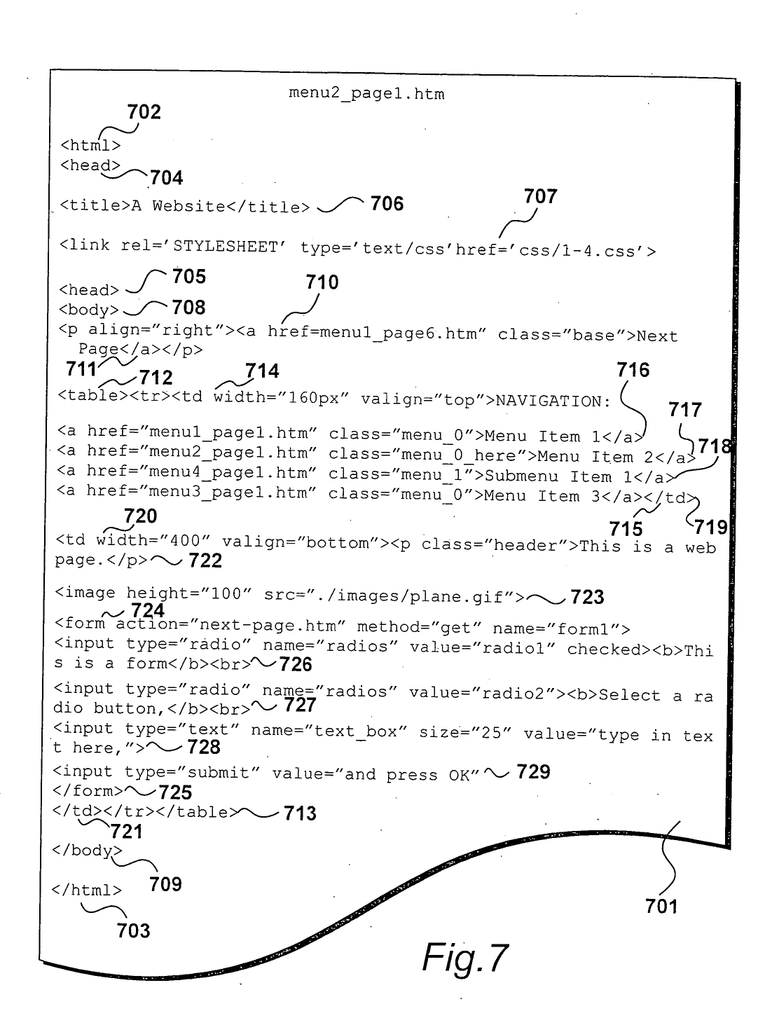

FIG. 7

FIG. 7 shows a simple HTML page 701 that could be stored on host server 106 in order to be accessed by one of user terminals 101 to 104. A markup language such as HTML provides formatting for the text contained therein and also provides a method for referencing video, audio and image data and other webpages. HTML consists of ‘tags’ which occur in pairs. Thus opening tag 702 indicates that everything following it is in HTML, and closing tag 703 indicates that the HTML is finished.

An HTML document has two parts, a header and a body. The header is contained within opening tag 704 and closing tag 705, and in this example contains code 706 indicating the title of the webpage and a link 707 to a cascading stylesheet. A header contains information that sets rules for how the code comprising the body is to be used. It can also contain metatags and keywords that will be searched by a search engine. It is not displayed on a browser.

The body, contained within opening tag 708 and closing tag 709, contains the information that is to be displayed. For example, tag 710 defines a hyperlink—the text within tags 710 and 711 is displayed and tag 710 identifies the page that the browser will open if the user clicks on this text. In other markup languages a hyperlink could be written differently, but it is is defined as any clickable or selectable link that allows navigation between webpages.

A table is defined between opening tag 712 and closing tag 713. The contents of its first column are delineated by opening tag 714 and closing tag 715 and lines 716, 717, 718 and 719 each define a hyperlink. The contents of the second column are contained within opening tag 720 and closing tag 721. Line 722 defines text to be printed on the screen and line 723 defines an image to be displayed.

The code contained within opening tag 724 and closing tag 725 defines a form. In this example tag 724 contains information defining where the information input into the form is to be sent, the method by which it is to be sent and the name of the form. The remainder of the code defines the form itself, with lines 726 and 727 each indicating a radio button, line 728 indicating a text box and line 729 indicating a “submit” button.

Many tags in HTML indicate formatting, for example the word “class” appears in tag 710. This designates a style to be applied that is defined in the stylesheet.

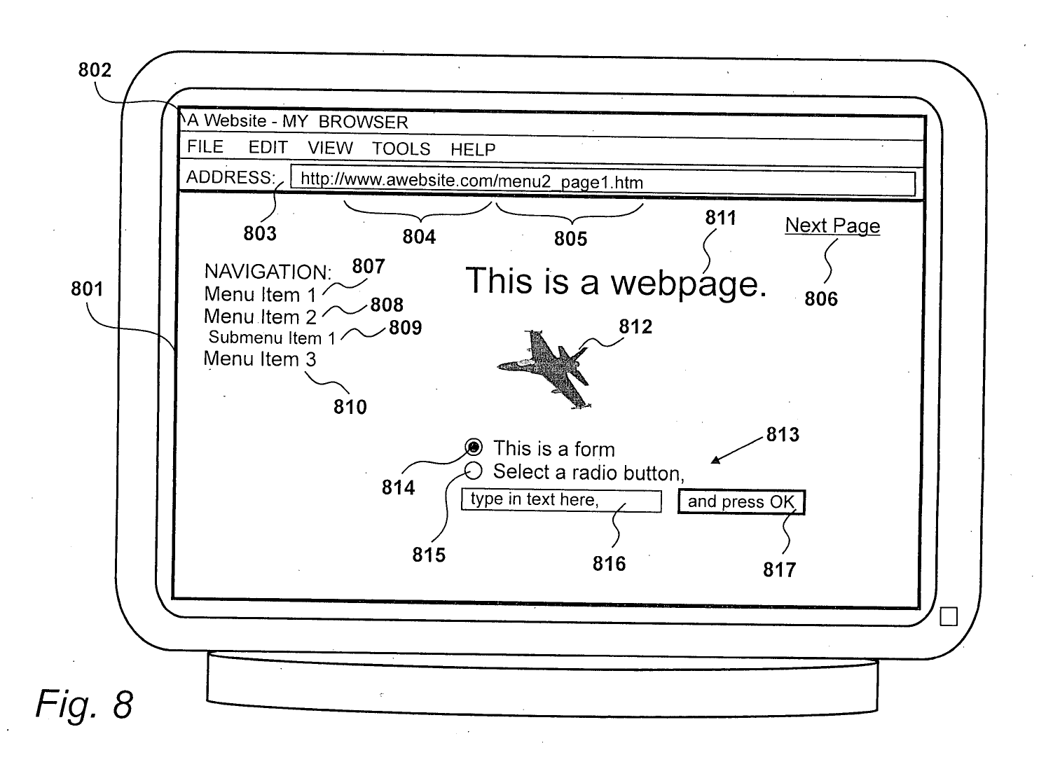

FIG. 8

FIG. 8 illustrates the viewable page that is displayed within the interface of a browser 801 on a VDU, when HTML page 701 is processed by the browser. The title indicated by line 706 appears in the top bar 802 of browser 801. The address 803 of the webpage is given by a Universal Resource Locator (URL). The first part 804 indicates a website while the second part 805 indicates a page on that website. The URL thus gives a unique reference to this page.

Hyperlink 806 is that defined by tags 701 and 711, while the hyperlinks 807, 808, 809 and 810, are defined by lines 716 to 719 respectively. Hyperlinks 806 to 810 provide navigation to the webpage. Hyperlink 806 takes the user to the next page in the website, while hyperlinks 807 to 810 are for menu items and take the user to other parts of the website. Most websites use a hierarchical menu structure such as this for easy navigation.

Text 811 is defined by line 722 and image 812 is defined by line 723.

The form 813 allows a user to input information. In this example, the user can select one of radio buttons 814 or 815 and type text into input box 816. On pressing button 817 the information is submitted to a location identified by the “action” attribute within tag 724. In this example the information is simply sent to another page, but usually the information will be passed to a script which performs an function such as updating a database, displaying the results in another page and so on

The “method” attribute can be either “get” or “post”. The “get” method converts the information into a query string and appends it to the URL. Thus in this example, if the user selected the first radio button and typed “hello” into the text box, the browser would open a page with the following URL:
http://www.awebsite.com/next-page.htm?radios=radio 1 &text_box=hello

The “post” method sends the information as a separate message from the URL and thus the information does not appear in the URL. This can be useful to stop users such as the users of terminals 101 to 104 bookmarking the URL containing the query string or changing the information in the URL, both of which are possible with the “get” method.

Webpages can be either static or dynamic. A viewable page created from a dynamic page is created “on-the-fly” every time it is displayed, although a cached version of it could be accessed if such is provided by the host server. The dynamic page has links, usually to databases, that insert information in the page. Often this information is different every time the page is refreshed. Examples of dynamic webpage content are advertisements, search results, online shopping information and such. The viewable page defined by HTML page 701 is static because it does not change appearance every time it is loaded. In order for it to change appearance either the. HTML itself, the stylesheet to which it is linked or the image which it references would have to be changed.

In a static page the navigation structure provided by the hyperlinks is hardcoded in. Usually a large amount of this structure appears on every page and so if the structure is changed most of the pages in the site have to be changed. For example, to reverse the order of menu items 736 and 737, line 716 would have to be moved to below line 718, since item 738 is a submenu of item 737 and would move with it. This analysis of the menu structure and movement of the code would have to be done manually. In a typical website this would be a large job to do on every page.

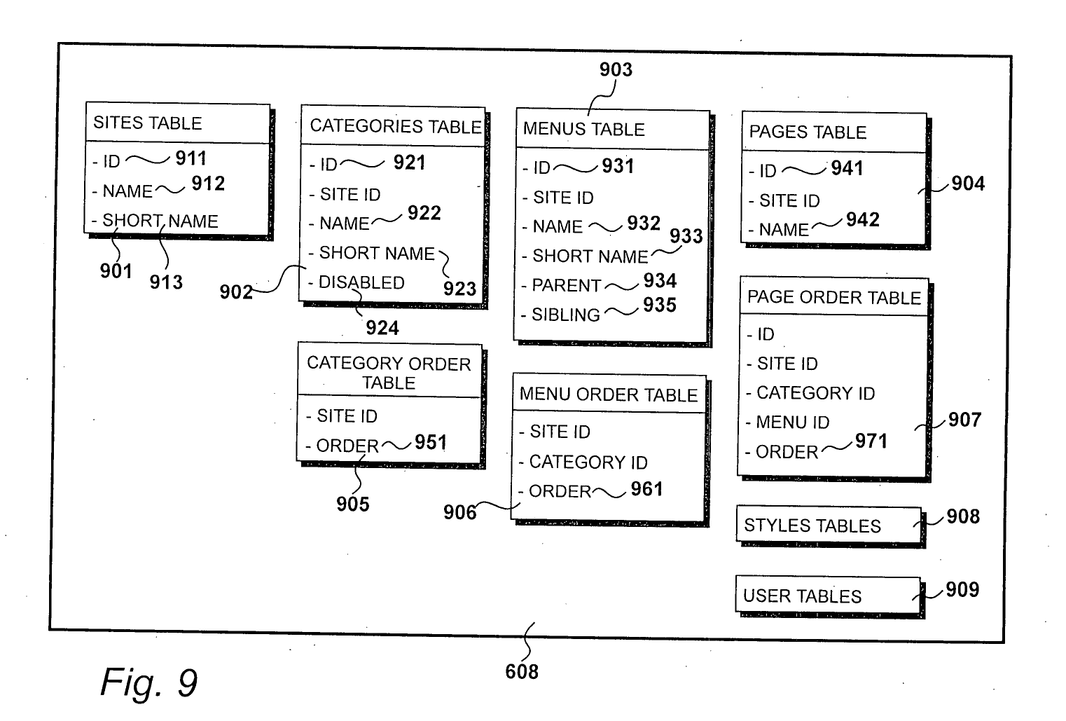

FIG. 9

The application herein described solves this problem by separating the navigation data for a website from its content throughout the web design process until the actual moment of creation of the website. If changes need to be made to any part of the website, including the menu structure, these can easily be made to the navigation data or content in the web design before recreating the website. Since the creation of the website is a quick process this means that making changes to the website is very easy.

Navigation data is in this embodiment provided by the application's navigation database 608 shown in FIG. 9. This, along with the content files 609, contains all the information necessary to allow the application to build websites from designs specified by the user of terminal 107. The database contains a number of tables, including sites table 901, categories table 902, menus table 903, pages table 904, category order table 905, menu order table 906 and page order table 907. It also includes styles tables 908 and user tables 909. It is a logical and editable representation of the navigation structure required for the website.

Sites table 901 stores an ID 911, a name 912 and a short name 913 for each website design stored on web design terminal 107. The number of possible sites is limited only by the amount of storage space on terminal 107 and by the number of entries allowed in a single table by database application 604, which is extremely large.

Categories table 902 stores an ID 921, a name 922 and a short name 923 for each category in each website design stored on terminal 107. For each category the ID 911 of the website to which it belongs and a field 924 indicating whether or not it is disabled is also included. A category forms the highest level of navigation structure. Each has its own menu structure and can have its own appearance.

Menus table 903 stores an ID 931, a name 932 and a short name 933 for each menu item in each website design stored on terminal 107. For each menu item the ID 911 of the website and the ID 921 of the category to which it belongs is also stored, along with a Parent field 934 and a Sibling field 935. For each menu item, the Parent field 934 indicates the ID 931 of its parent menu item, that is the menu item of which it is an immediate sub-menu item. If a menu item has no parent, that is to say it is a top-level menu item, this field has a value of 0. The Sibling field 935 indicates the ID 931 of its elder sibling, if it has one, which is to say the sub-menu item that has the same parent item and is immediately above it in the hierarchy. If there is no elder sibling this field is set to 0. Also, each top-level menu item, having no parent, is considered to have no sibling, and so this field has a value of 0 for each menu item that has a value of 0 in its parent field.

Pages table 904 stores an ID 941 and a name 942 for each page in each website design stored on terminal 107. For each page the ID 911 of the website to which it belongs is also stored. The content of each page is stored as one of content files 609, with a name that references the page's ID 941.

Category order table 905 stores a comma-delimited order string 951 for each site ID 911, that gives the order in which the categories should appear for that website. For example, if a website contains categories having category IDs 1, 2 and 3, and they are to appear in that same order on the website, then the order string 951 would be “,1,2,3”.

Menu order string 906 stores a comma-delimited menu-order string 961 for each combination of category ID 921 and site ID 911, that gives the order in which the top-level menu items, that is those having values of 0 in their parent field 934, should appear for that website.

Page order table 907 stores a comma-delimited page-order string 971 for each menu item ID 931 in menus table 903. It also includes the site ID 911 and category ID 921 for that menu item ID 931.

Styles tables 908 store references, for each category, to fonts, pre-defined styles, user-defined styles and so on for use in cascading stylesheets. User tables 909 store user information for use in an alternative embodiment (not shown) where web design terminal 107 is replaced by a network of web design terminals. In this embodiment user information and, in particular, user permissions, are stored in these tables,

The design of database described in detail herein is only an example of navigation data that could be used. Other database designs that fulfil the tasks of storing a logical and editable representation of a navigation structure and allowing editing of that structure, and that are suitable for being processed in combination with content files to produce pages representing the navigation structure could be used. In addition, the data need not be in the form of a database and could take other forms.

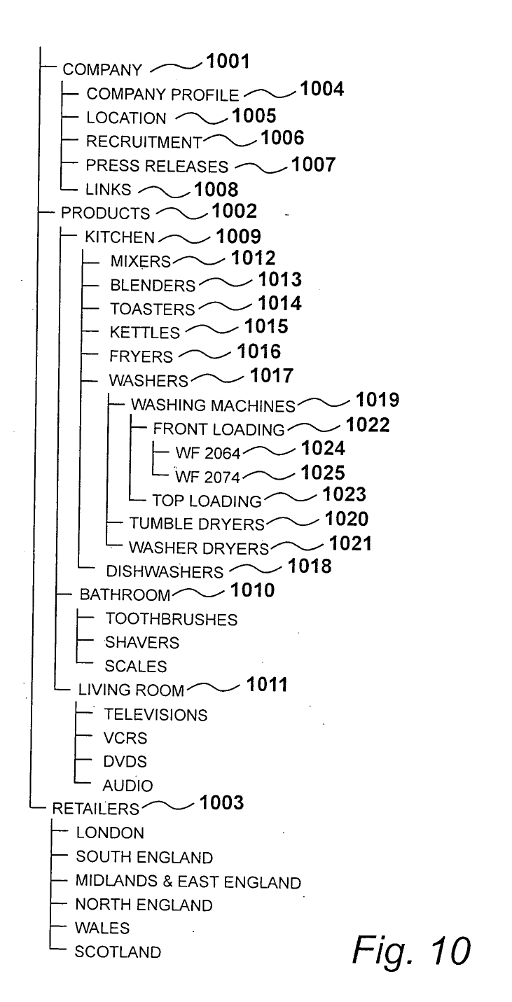

FIG. 10

FIG. 10 illustrates an example of a navigation structure that a web designer has been given in order to create a website. In this example the client is a company that manufactures electrical appliances but does not sell them. The website should therefore contain information about the company, information about its product lines and information about where the products can be bought.

Thus the three highest level items in the navigation structure are COMPANY category 1001, PRODUCTS category 1002 and RETAILERS category 1003. Each of categories 1001 to 1003 has a menu structure appended to it. None of these is shown in full due to space restrictions. Thus category 1001 has top-level menu items COMPANY PROFILE item 1004, LOCATION item 1005, RECRUITMENT item 1006, PRESS RELEASES item 1007 and LINKS item 1008. Each of these menu items may have sub-menu structures, and each has at least one webpage associated with it.

Category 1002 has a large sub-menu structure associated with it. It has three top-level menu items, KITCHEN item 1009, BATHROOM item 1010 and LIVING ROOM item 1011. These split the products into the rooms in which they may be used. Below that each top-level menu item has a number of first-level sub-menu items grouping products together by function. For example, menu item 1009 has seven first-level sub-menu items, MIXERS item 1012, BLENDERS item 1013, TOASTERS item 1014, KETTLES item 1015, FRYERS item 1016, WASHERS item 1017 and DISHWASHERS item 1018. Of these, only the sub-menu structure of item 1017 is shown, although each item will have its own sub-menu structure.

Thus first-level sub-menu item 1017 contains three second-level menu items, WASHING MACHINES item 1019, TUMBLE DRYERS item 1020 and WASHER DRYERS item 1021. Again, although each of items 1019 to 1021 has its own sub-menu structure, only that of item 1019 is shown. Thus second-level sub-menu item 1019 has two third-level sub-menu items, FRONT LOADING item 1022 and TOP LOADING item 1023. Similarly, third-level sub-menu item 1022 has two fourth-level sub-menu items, WF 2064 item 1024 and WF 2074 item 1025. In this example these are the lowest sub-menu items, identifying the products themselves. However, in this embodiment there can be nine levels of sub-menu if required, giving eleven levels of navigation structure in all. However, there is no real limit on how many sub-menus can be allowed for and in other embodiments more sub-menus could be available.

Category 1003 identifies retailers of the company's products, grouped by region, and contains a similar hierarchical sub-menu structure where the user can select ever-more-specific regions until eventually reaching information on a specific store.

Each menu item, the definition of which includes top-level menu items and sub-menu items, has at least one page associated with it. The number of pages that can be associated with a menu item is essentially infinite.

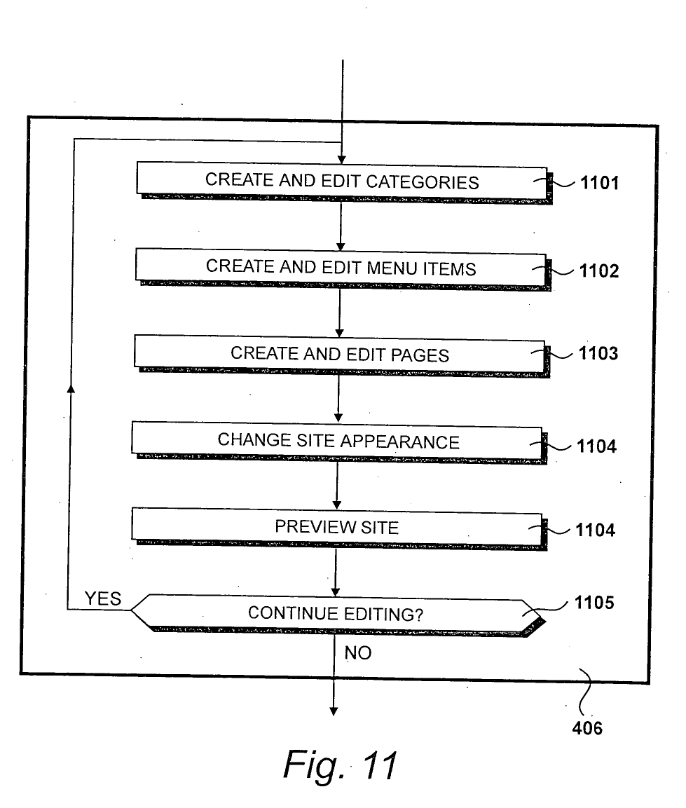

FIG. 11

FIG. 11 details step 406 at which a website design loaded at step 405 is edited. To continue the example described with reference to FIG. 10, in order to create the specified website a web designer would load a default empty design and give it a unique name at step 405, and then edit it at step 406.

Thus at step 1101 the user creates and edits the categories, at step 1102 the user creates and edits menu items, and at step 1103 the user creates and edits pages. At step 1104 the user can change the site appearance, for example fonts, banner images and text, background colours and so on. At step 1105 the user can preview the website, whereupon the website will be previewed to him in his browser 603 as it will appear in the final version.

At step 1106 a question is asked as to whether the user wishes to continue editing this website design. If this question is answered in the affirmative then control is returned to step 1101. However, if it is answered in the negative then step 406 is completed. At this point, if the website design is finished, the website can be created at step 408.

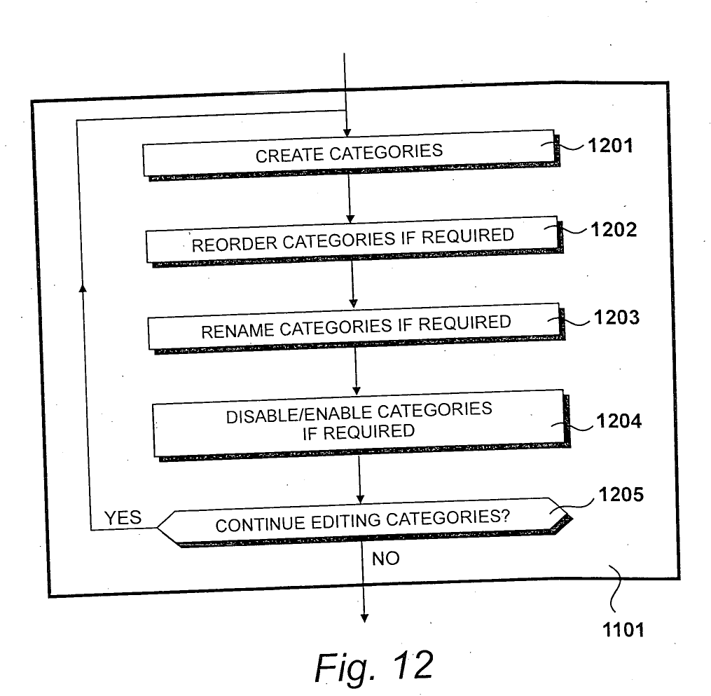

FIG. 12

FIG. 12 details step 1101 at which the user may create and edit categories. At step 1201 he creates categories, while at step 1202 he can reorder them if required. At step 1203 he can rename them if required and at step 1204 he may disable or enable them if required.

At step 1205 a question is asked as to whether the user wishes to continue editing the categories, and if this question is answered in the affirmative control is returned to step 1201 where the user may continue the process by creating more categories if required. If the question is answered in the negative then step 1101 is completed.

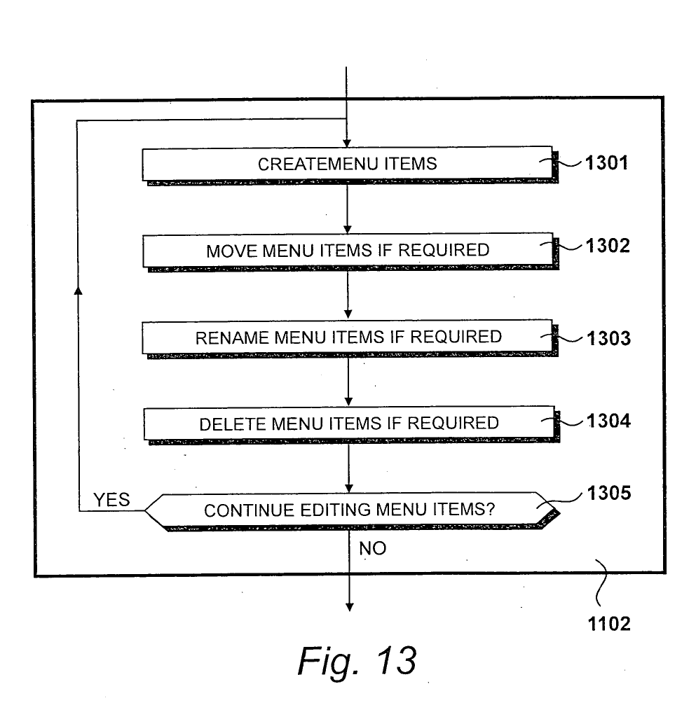

FIG. 13

FIG. 13 details step 1102 at which the user can create and edit menu items. At step 1301 he creates menu items and at step 1302 he can move them within the menu structure if required. At step 1303 he can rename them if required and at step 1304 he can delete them.

At step 1305 a question is asked as to whether the user wishes to continue editing menu items, and if this question is answered in the affirmative control is returned to step 1301 at which he may create more menu items if required. If it is answered in the negative then step 1102 is completed.

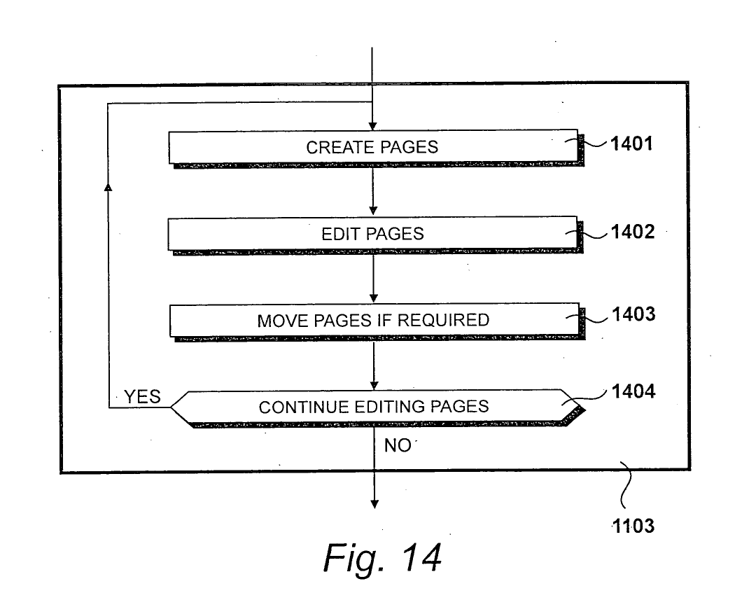

FIG. 14

FIG. 14 details step 1103 at which the user may create and edit pages. At step 1401 he can create pages and at step 1402 he edits the content of these pages. At step 1403 he can move pages within the menu structure if required.

At step 1404 a question is asked as to whether the user wishes to continue editing pages and if this question is answered in the affirmative control is returned to step 1401 at which the user can create more pages if required. If the question is answered in the negative then step 1103 is completed.

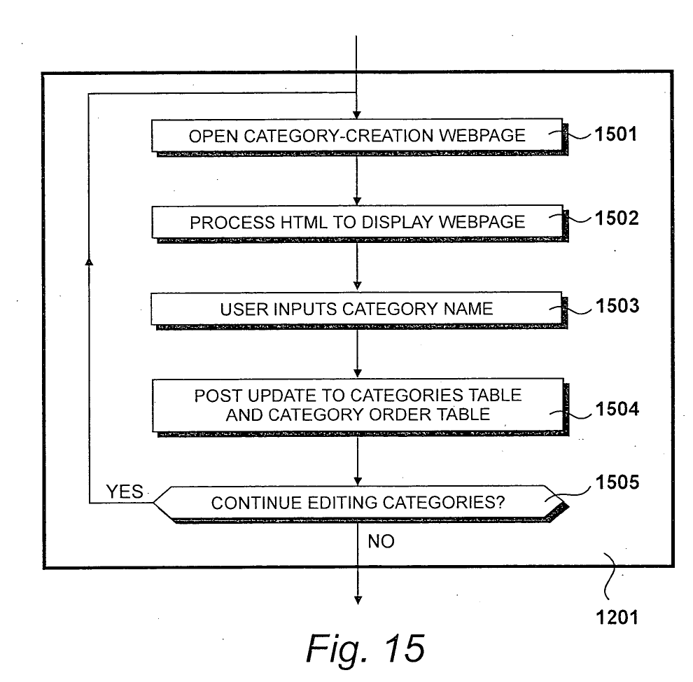

FIG. 15

FIG. 15 details step 1201 at which the user creates categories for his website design. At step 1501 one of the application webpages 606, called the category-creation webpage, is opened by browser 603. This involves the browser requesting operating system 601 to load the webpage from the hard drive 305 into memory 303. At step 1502 the browser processes the HTML, including embedded code such as PHP, in the webpage and displays it on VDU 104 within the interface of browser 603.

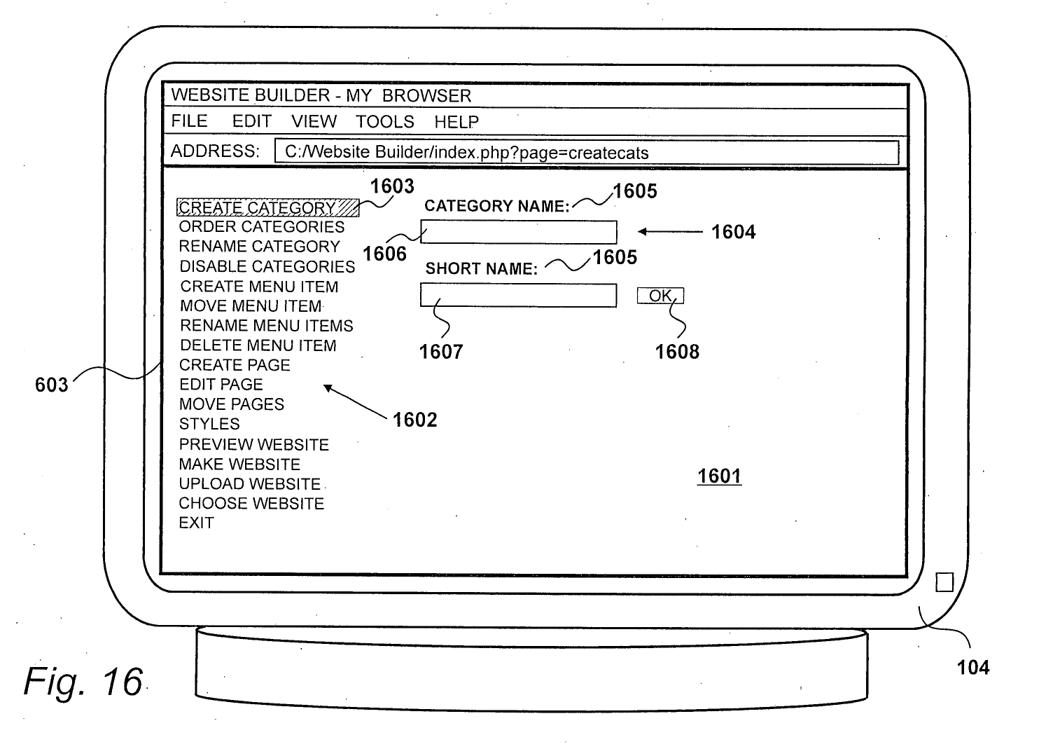

The displayed page, which will be discussed further with reference to FIG. 16, includes text boxes to input a name and a short name for a new category, and thus the user inputs the names and presses a button labelled “OK” at step 1503. At step 1504 an update is posted to categories table 902 and category order table 905 and at step 1505a question is asked as to whether there is another category to create. If this question is answered in the affirmative control is returned to step 1501 and the category-creation page is reopened. If it is answered in the negative, however, step 1201 is completed.

An error message will be created during this step if the user inputs a name or short name that duplicates any record already present in categories table 921. In this case the user would be invited to re-enter the text.

FIG. 16

FIG. 16 shows category-creation webpage 1601 displayed in browser 603. The lists of functions 1602 displayed on the left-hand side allow a user to access various functions for use in designing one or more websites. Thus the CREATE CATEGORY function 1603 is currently highlighted to show that this function is in use. It will be understood that the workflow shown in FIG. 11 and elaborated on with reference to FIGS. 12 to 37 is only an illustration of the workflow of a website designer; the functions are accessed via buttons 1601 and may be carried out in any order.

FIG. 16 also illustrates how the web design application herein described uses browser 603 as an interface. Successive application webpages 606 are opened within the browser that, in conjunction with application script 607, allow a user to update navigation database 608 and content files 609 in order to design a website. It will be appreciated that this is by no means the only method of providing an interface for a website design application that separates navigation data from content data.

The way in which the browser is used as an interface is now described more fully. In this example, the category-creation webpage is opened. It consists of functions 1602, each of which is a hyperlink to another of application webpages 606. Area 1604 is a form, consisting of text 1605, text boxes 1606 and 1607, and submit button 1608. After the user has entered text into boxes 1606 and 1607 he presses button 1608. This causes the entered text to be sent using the post method to one of application scripts 607, that performs the function of adding a new line to categories table 902 containing the appropriate information, retrieving the category ID 921 of this new record and adding it, with a comma delimiter, to order string 951 in category order table 905.

Not every function available to the user will be described in such detail as this one, since the application interface herein described is extremely large.

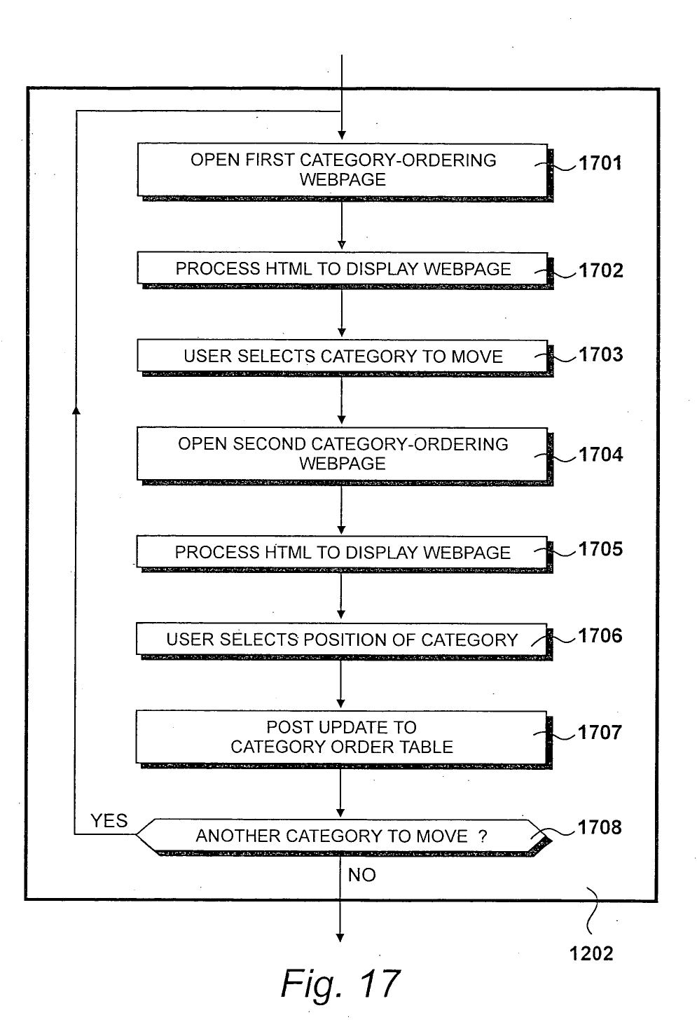

FIG. 17

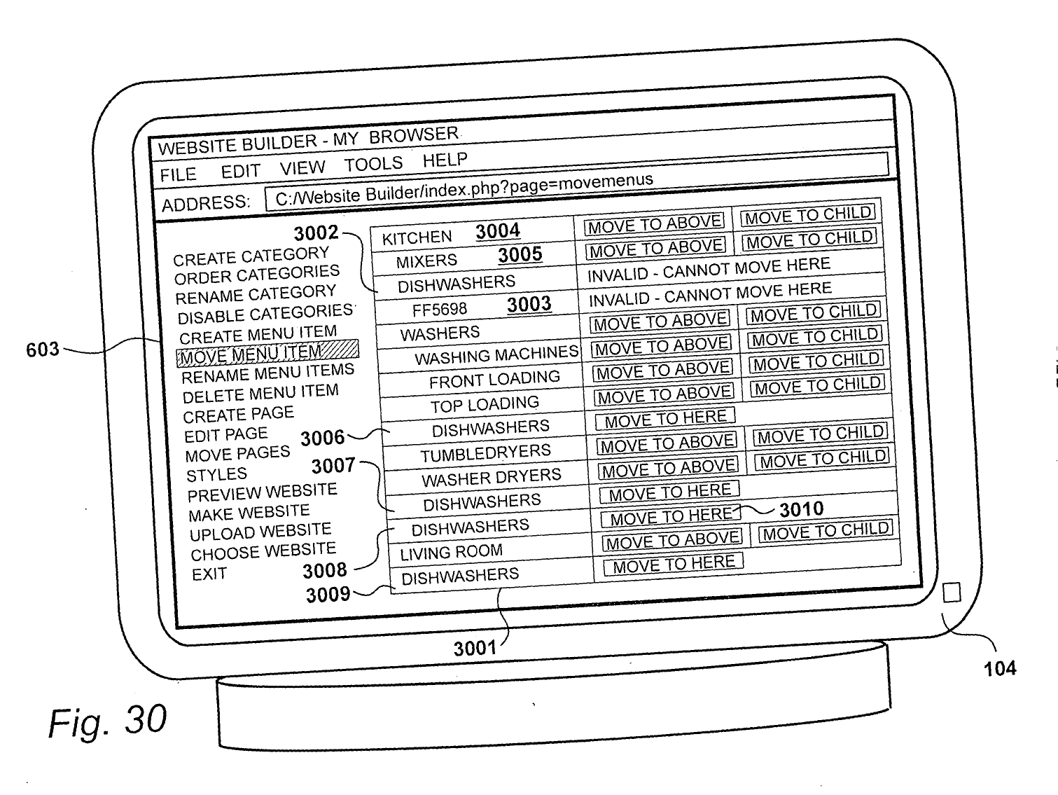

FIG. 17 details step 1202 at which the user reorders the categories he has created, if required. At step 1701 a first category-ordering webpage, one of application webpages 606, is opened and at step 1702 the browser processes the HTML contained therein to display the page to the user on VDU 104. At step 1703 the user selects a category to reorder and at step 1704 the browser opens a second category-ordering page. At step 1705 the browser processes the HTML contained therein to display the webpage. to the user on browser 104. This page includes a display of all the categories in the site with various submit buttons allowing the user to place the category where he wishes. This page is similar to the menu-placement webpage, which will be described further with reference to FIG. 30.

At step 1706 the user selects a position for the category within the ordering by pressing one of the submit buttons, whereupon information is sent using the post method to one of application scripts 607, which has the effect of changing order string 951 in category order table 905.

At step 1708 a question is asked as to whether there is another category to move and if this question is answered in the affirmative control is returned to step 1701 and the first category-ordering webpage is reopened. If it is answered in the negative then step 1202 is concluded.

Steps 1203 and 1204 will not be described in detail here. They allow the user to, respectively, change the name of any of the categories and disable or enable them. The former offers an interface to change the name field 922 or short name field 923 in categories table 902; the latter offers an interface to change the disabled field 924 in categories table 902. This field may only take a true or false value. A disabled category, although it, its menu structure and its pages may be fully edited using this application, will not be displayed on a previewed or created website. This feature allows a user to fully create a new category that is not suitable for putting on the website until a specific day, and then upload it very quickly.

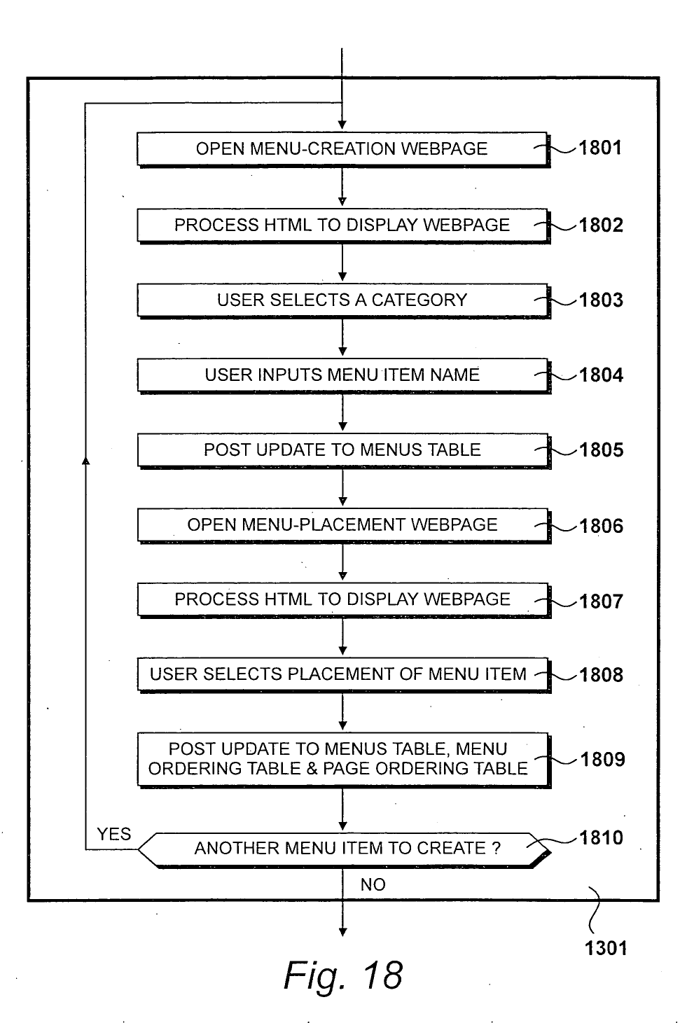

FIG. 18

FIG. 18 details step 1301 at which the user creates menu items. At step 1801 the browser opens a menu-creation webpage, one of application webpages 1606, and at step 1802 the browser processes the HTML contained therein to display the page to the user on VDU 104. This webpage displays the names of all the categories in the site, each with a radio button, such that the user may select one of the categories at step 1803. It also includes a text box and a submit button such that the user may input a menu item name at step 1804. When the user presses the submit button the category selection and menu item name are sent to one of application scripts 607 using the post method, whereupon said script updates menus table 903 at step 1805 by adding a new record.

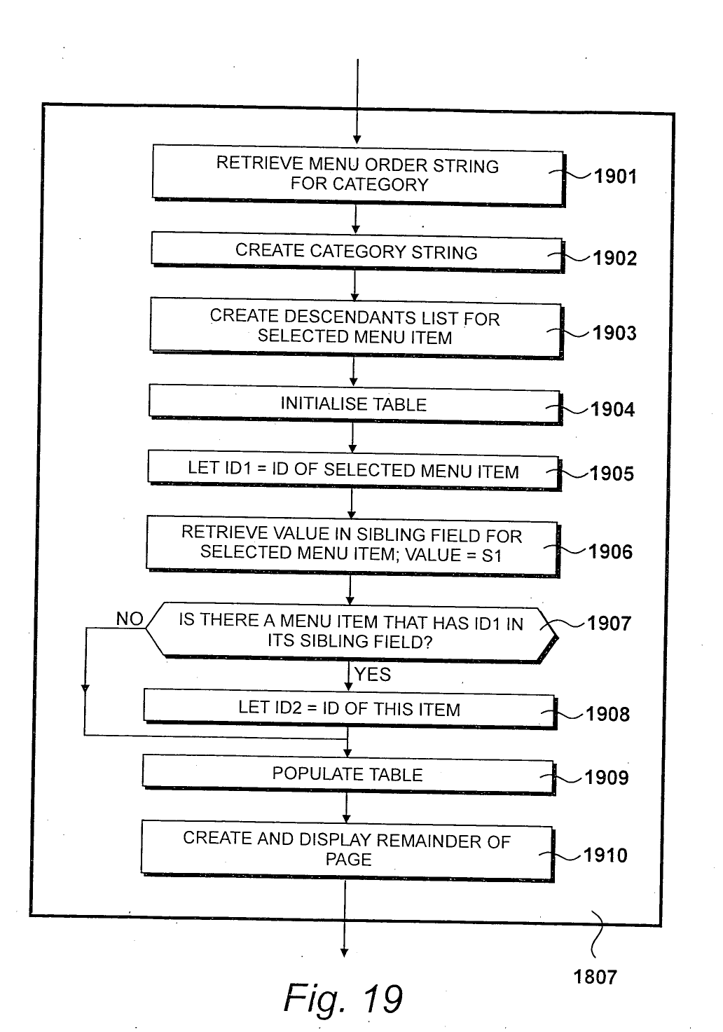

At step 1806 a menu-placement webpage is opened, one of application webpages 606, and at step 1807 the browser processes the HTML contained therein to display the webpage to the user on VDU 104. This webpage offers the user many places to position the menu item, which the user does at step 1808 whereupon menus table 903, menu ordering table 906 and page ordering table 907 are updated at step 1809. These steps will be further described with reference to FIGS. 19 to 29.

At step 1810 a question is asked as to whether there is another menu item to create, and if this question is answered in the affirmative control is returned to step 1801 and the menu-creation webpage is reopened. If it is answered in the negative then step 1301 is concluded.

FIG. 19

FIG. 19 details step 1807 at which the browser processes the HTML and other code in the menu-placement webpage in order to display a viewable webpage to the user on VDU 104. The viewable webpage thus displayed is shown at FIG. 30. At step 1901 menu order table 906 is queried to retrieve the menu order string 961 for the current site and the category selected at step 1803. At step 1902 a category string is created, which is, a comma-delimited string representing the menu structure of the selected category. At step 1903 a descendants list is created for the menu item that is currently selected, that is to say, the menu item that is being created. This list contains the ID 931 of the selected menu item, the IDs of all its sub-menus, the IDs of all its sub-menus' sub-menus, and so on. When the menu-placement page, which is currently being discussed, is opened during the creation of a menu item the descendants list is empty and not necessary since the menu item has not yet been placed. However, this page is also used during the movement of a menu item and then the descendants list is needed so that the user is not offered an option of placing a menu item relative to itself or its direct descendants.

At step 1904 a table is initialised. At step 1905 a variable ID1 is set to be the ID of the selected menu item and at step 1906 the value in the sibling field 935 of menus table 903 is retrieved for this ID; this value is set to be the value of a variable S1. At step 1907 a question is asked as to whether there is a menu item that has the value ID1 in its sibling field 935 in menus table 903, and if this question is answered in the affirmative the value of a variable ID2 is set to be the ID 931 of this menu item. Thus some preliminary variables have been set, with ID1 being the menu ID 931 of the menu item that is being positioned, the variable Si being the menu ID 931 of its elder sibling, if it has one, or zero if it has not, and the variable ID2 being the menu ID 931 of the selected menu item's younger sibling, if it has one.

Following step 1908, and if the question asked at step 1907 is answered in the negative, at step 1909 the table initialised at step 1904 is populated and at step 1910 the remainder of the webpage is created and displayed.

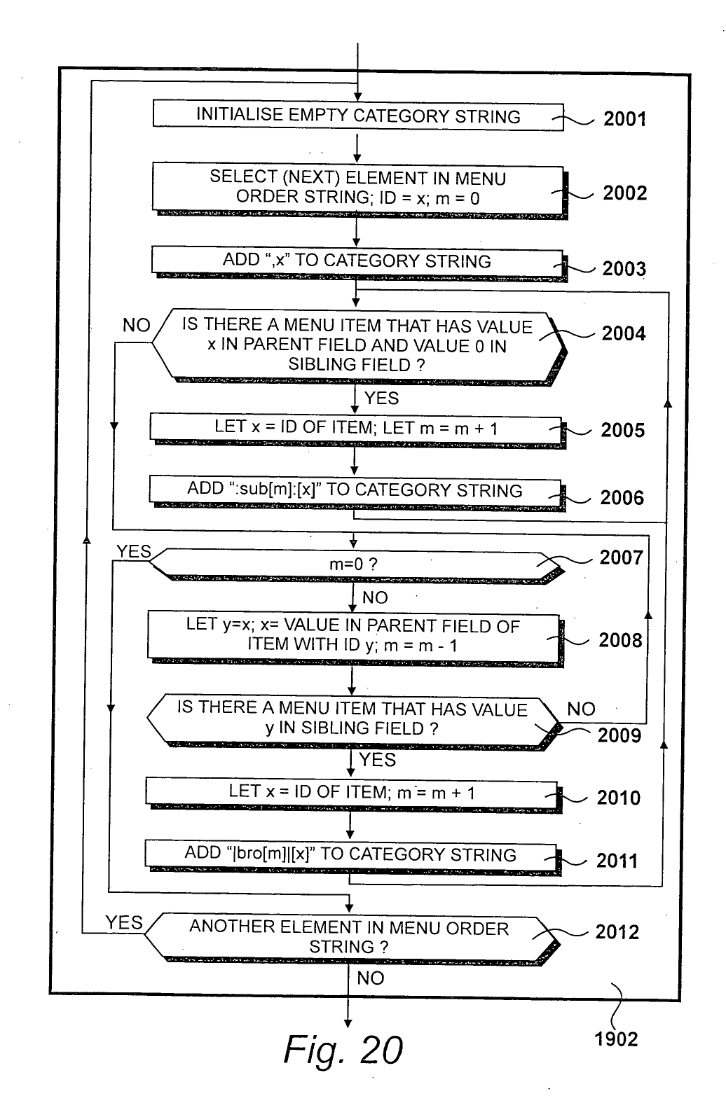

FIG. 20

FIG. 20 details step 1902 at which the category string is created. At step 2001 the first element in the menu order string retrieved at step 1901 is selected. This is a comma-delimited string, and so the menu ID 931 of the menu item to which the element refers is obtained simply by removing the comma from the element. This ID is set to be the value of a variable x, while a counting variable m is set to be 1. At step 2003 a new element is added to the category string, this element being a comma followed by the value of the variable x, as set at step 2002.

At step 2003 a question is asked as to whether there is a menu item that has the variable x as the value in its parent field 934 in menus table 903 and a value of zero in the sibling field 935. If this question is answered in the affirmative then the menu item found is a first sub-menu of the menu item identified by the variable x, and so at step 2004 the variable x is now set to be the ID 931 of this menu item, with m being incremented by 1. At step 2005 a new element is added to the category string. This element is formed by appending the value of the variable m to the word “sub”, enclosing the whole in colons and adding the value of the variable x to the end.

Control is now returned to step 2003 where a sub-menu of this newly identified menu item is found, if one exists. Eventually, this question will be answered in the negative when a menu item with no sub-menus is found. At this point the algorithm goes back up a menu level and looks for siblings. To this end a question is asked at step 2006 as to whether the variable m is equal to zero. The variable m represents the level of the menu item currently identified by the variable x, and so if at any point it is equal to zero the menu item under consideration is at the top level and thus recourse must be made to menu order string 961 to find siblings, since these cannot be identified from menus table 903. However, if the question asked at step 1006 is answered in the negative then at step 2007 the value of a variable y is set to be the current value of variable x, and the variable x is set to be the value in the parent field 934 of the menu item that has this ID; that is to say the variable x is now the ID of the parent menu item of the menu item previously under consideration. The variable m is decremented by 1.

At step 2008 a question is asked as to whether there is a menu item that has the variable y as a value in its sibling field 935 in menus table 903. If this question is answered in the affirmative then a younger sibling of the menu item currently under consideration has been found and so the variable x is set to be the ID of this found item and the variable m is incremented by 1 at step 2009. At step 2010 a new element is added to the category string. This element consists of the value of the variable m appended to the word “bro”, all being enclosed by modulus signs, followed by the current value of variable x. Control is then returned to step 2003 to check whether this newly identified menu item has any sub-menus.

If however, the question asked at step 1008 is answered in the negative, control is returned to step 2006 in order that any siblings of the parent of the menu item currently under consideration can be found.

If, at any time, the question asked at step 2006 is answered in the affirmative, to the effect that the variable m is equal to zero, the at step 2011 a question is asked as to whether there is another element in menu order string 961. If this question is answered in the affirmative then control is returned to step 2002 and the next element is selected. If it is answered in the negative then the algorithm of step 1902 is concluded.

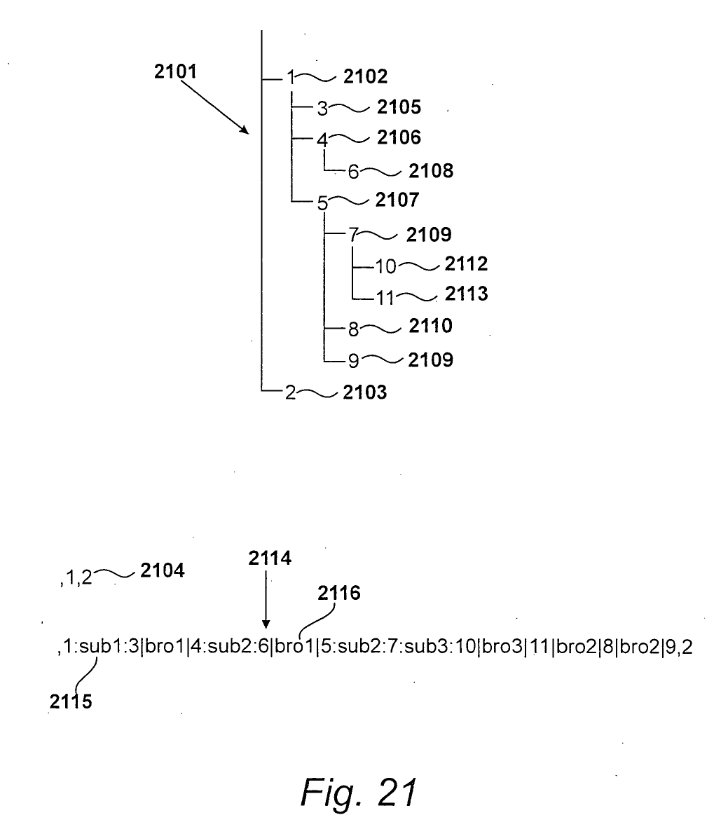

FIG. 21

FIG. 21 shows an example of a category string. An example of a menu structure is shown generally at 2101, with the top-level menu items 2102 and 2103 having the menu IDs 1 and 2 respectively, occurring in the order set out by menu order string 2104. Top-level menu item 2102 has three first-level sub-menu items 2105, 2106 and 2107, having the IDs 3, 4 and 5 respectively, and sub-menu item 2106 has a second-level sub-menu item 2108 with the ID 6. Menu item 2107 has three second-level sub-menus 2109, 2110 and 2111 having the IDs 7, 8 and 9 respectively, and sub-menu item 2109 has two second-level submenu items 2112 and 2113 having the IDs 10 and 11 respectively. Top-level menu item 2103 has no submenu structure.

This menu structure is represented by the category string 2114. Each top-level menu item is represented by an element that is a comma followed by its ID 931. Any sub-menu item that has no elder sibling is represented by an element identifying it as such, for example the menu item with ID 3 is shown to be a sub-menu at the first level with no elder siblings by having the delimiter shown at 2115, which is :sub1:. Any menu item that has an elder sibling is also identified, for example the menu item with ID 5 has the delimiter shown at 2116, which is |bro1|.

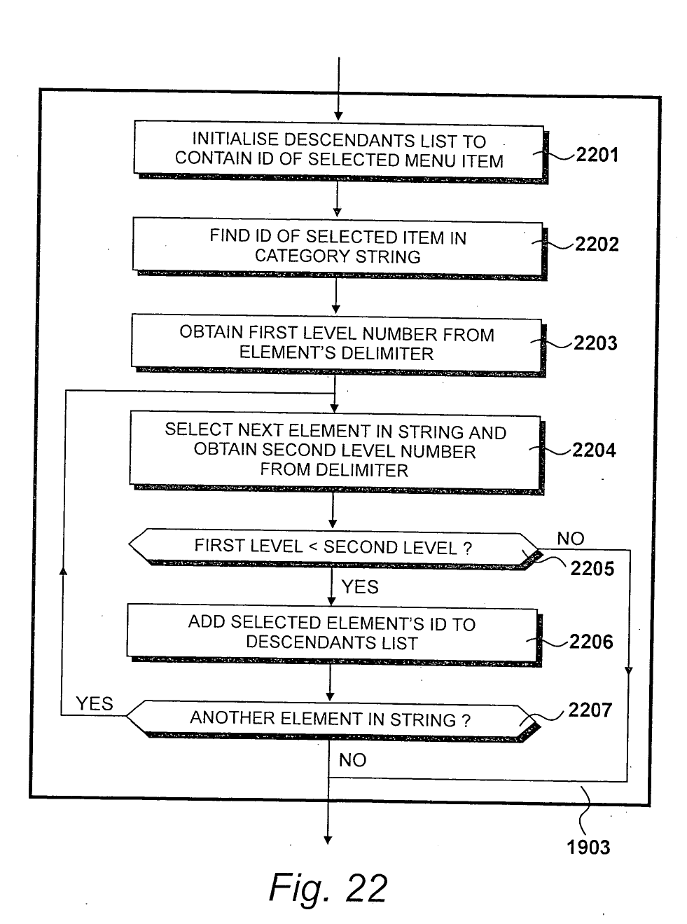

FIG. 22

Once the category string has been created at step 1902 a descendants list is created at step 1903. At step 2201 a descendants list is initialised that contains the ID of the menu item that is being created, called the selected menu item. At step 2202 the ID 931 of this item is found in the category string created at step 1902, and at step 2203 a first level number is obtained from the element's delimiter. A delimiter consisting of a comma gives a level number of zero while any other delimiter's level is indicated by the number contained within it, thus for example :sub1: is at level one while |bro2| is at level two.

At step 2204 the next element in the category string is selected and a second level number is obtained from its delimiter. At step 2205 a question is asked as to whether the first level number is less than the second level number. If this question is answered in the affirmative then the selected element's ID 931 is added to the descendants list, since the menu item that it represents is a direct descendent of the currently selected menu item. At step 2207 a question is asked as to whether there is another element in the category string and if this question is answered in the affirmative control is returned to step 2204 and the next element is selected.

If the question asked at step 2205 is answered in the negative, to the effect that the first level number is greater than or equal to the second level number, the element selected represents a menu item that is not a direct descendant of the selected menu item. It is therefore impossible to find any further direct descendants and so at this point, or if the question asked at step 2207 is answered in the negative to the effect that are no more elements in the category string, step 1903 is concluded and the descendants list has been created.

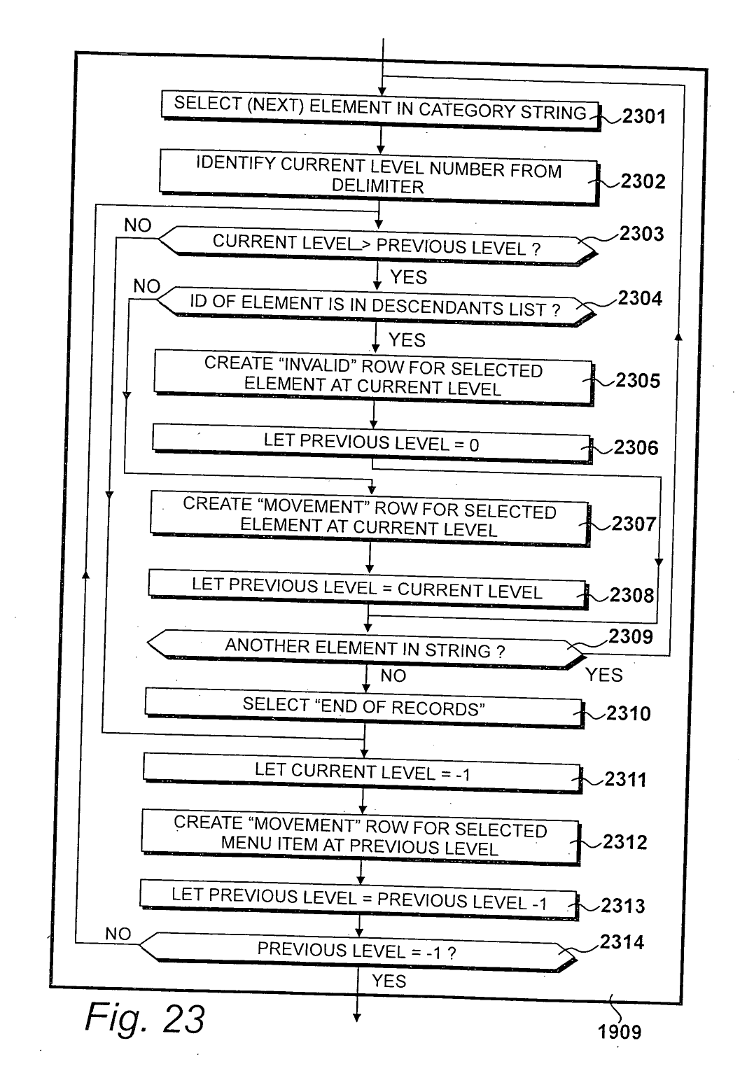

FIG. 23

FIG. 23 details step 1909 at which the table initialised at step 1904 is populated. At step 2301 the first element in the categories string created at step 1902 is selected and at step 2302 a current level number is identified from the element's delimiter, in the same way as at step 2203. At step 2303 a question is asked as to whether this current level is greater than or equal to a previous level. On the first iteration of this algorithm there is no previous level and so this question is answered in the affirmative. At step 2304 a next question is asked as to whether the ID 931 contained in the element is in the descendants list created at step 1903. If this question is answered in the affirmative then an “INVALID” row is created for the selected element at the current level at step 2305. This row will indicate that the currently selected menu item cannot be moved with respect to the menu item represented by the currently selected element, since it is the selected menu item itself or a direct descendant of it. The previous level is then set to be zero at step 2306.

If the question asked at step 2304 is answered in the negative, to the effect that the ID 931 of the selected element is not in the descendants list, then at step 2307 a “MOVEMENT” row is created for the selected element at the current level. This row will contain buttons that allow the user to select a position for the currently selected menu item with respect to the menu item identified by the currently selected element. At step 2308 the previous level is set to be the current level and at step 2309 a question is asked as to whether there is another element in the category string. If this question is answered in the affirmative control is returned to step 2301 and the next element is selected.

Alternatively, if there are no more elements in the string, then “END OF RECORDS” is selected at step 2310, that is to say that the pointer that is selecting elements in the category string is moved to after the final element. At this point, and if the question asked at step 2303 is answered in the negative, to the effect that the current level is less than the previous level, control is directed to step 2311, where the current level is set to be minus 1. At step 2312 a “MOVEMENT” row is created for the selected menu item at the previous level. This will give the user an opportunity to move the selected menu item to a position as the youngest sibling of a family of submenus. At step 2313 the previous level is decremented by 1 and at step 2314 a question is asked as to whether the previous level now equals minus 1. If this question is answered in the negative control is returned to step 2303 and the question is asked again as to whether the current level is greater than or equal to the previous level. However, if the question is answered is answered in the affirmative then step 1909 is concluded and all the rows necessary for the table-have been created.

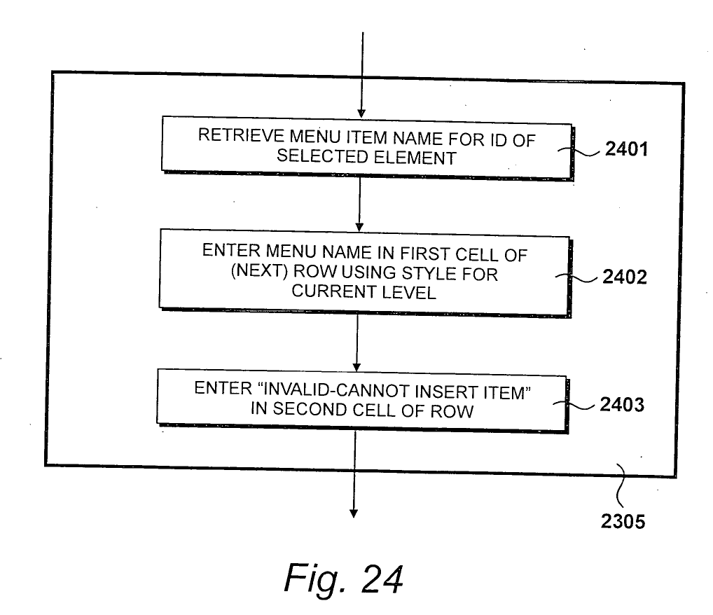

FIG. 24

FIG. 24 details step 2305 at which an “INVALID” row is inserted in the table. At step 2401 the menu item name for the ID of the *selected element is retrieved from menus table 903 and at step 2402 this menu name is entered in the first cell of the next row of the table, using an indent style suitable for the current level as identified at step 2302. At step 2403 the text “INVALID—CANNOT INSERT ITEM” is entered in the second cell of this row.

As previously discussed, when this menu-placement page is opened during the creation of a menu item the descendants list will be empty and this type of row will not need to be inserted, since as yet the selected menu item has no position. However, the descendants list is necessary when this page is used during the “MOVE MENU ITEM” function. The “INVALID” row will then be inserted in order to prevent a menu item being positioned with respect to itself or its descendants, which would cause an error.

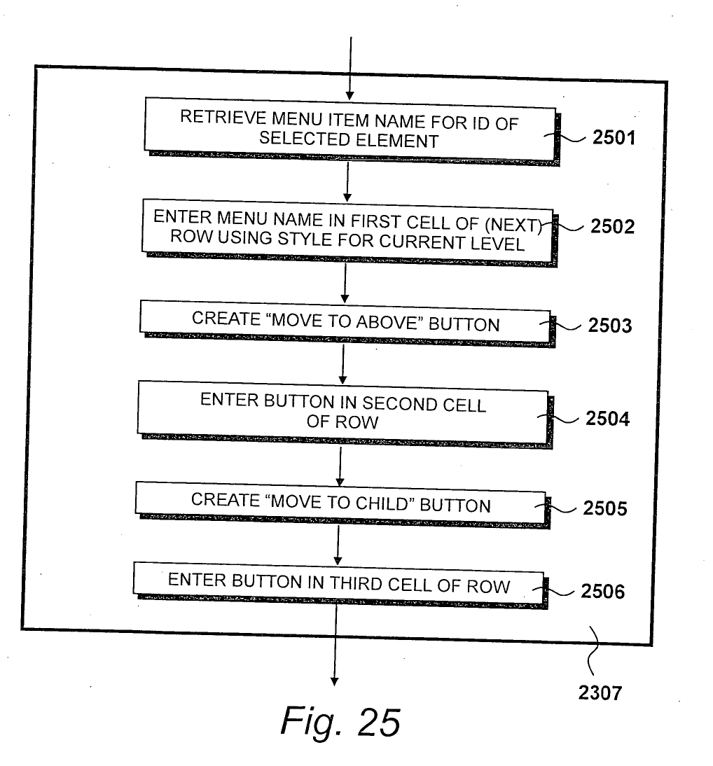

FIG. 25

FIG. 25 details step 2307 at which a “MOVEMENT” row is created for the menu item identified by the currently selected element. At step 2501 the menu item name 932 for the menu ID 931 contained in the selected element is retrieved from menus table 903, and at step 2502 this name is entered in the first cell of the next row of the table, using an indent style appropriate for the current level identified at step 2302. At step 2503 a “MOVE TO ABOVE” button is created for this item and at step 2504 this button is entered in the second cell of the rows. At step 2505 a “MOVE TO CHILD” button is created for this item and at step 2506 this button is entered in the third cell of the row.

Thus during step 2507 two buttons are created. The first, if selected, will move the selected menu item to be an elder sibling of the menu item named in the first cell, while the second will move the selected menu item to be its child.

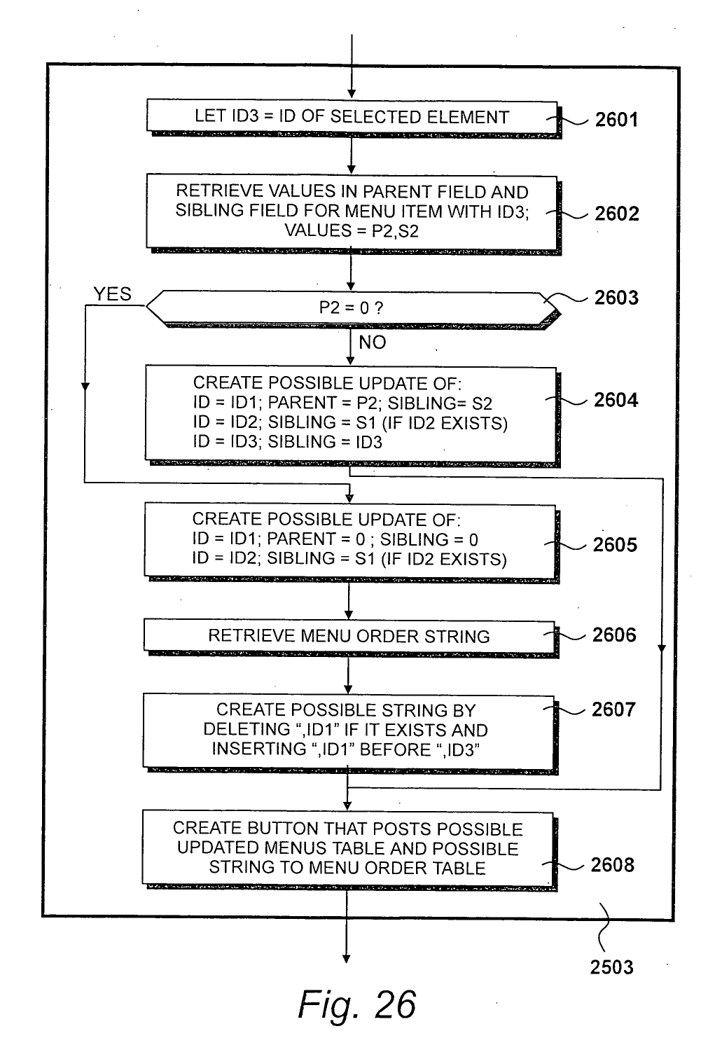

FIG. 26

FIG. 26 details step 2503, at which a button moving the selected menu item to be the elder sibling of the menu item identified in the first cell is created. At step 2601 a variable ID3 is set to be the ID 931 contained in the selected element and at step 2602 the values in the parent field 934 and sibling field 935 of menus table 903 for the menu item having this ID are retrieved, and set to be the values of the variables P2 and S2 respectively. At step 2603 a question is asked as to whether P2 is equal to zero. This is equivalent to asking whether the selected element identifies a menu item that is at the top level. If it is answered in the negative then at step 2604 a possible update is created that will be used to update menus table 903 if the button currently being created is selected by the user for placement of the selected menu item. This update is as follows: for the menu item having a menu ID 931 of the value of the variable ID1, the parent will be set to be the value of the variable P2 and the sibling will be set to be the value of the variable S2; for the menu item having ID 931 of the value of the variable ID2, if ID2 exists, the sibling will be set to be the value of the variable Si; while for the menu item having an ID of the value of the variable ID3 the sibling will be set to be the value of the variable ID1. All of this has the effect of inserting the selected menu item as an elder sibling of the menu item named in the first cell.

If the question asked at step 2606 is answered in the affirmative, to the effect that the value of the variable P2 is equal to zero, then at step 2606 a different possible update is created. This carries the information that for the menu item having menu ID 931 of the value of the variable ID1 its parent and sibling fields will both be zero, while for the item having ID of the value of the variable ID2, if it exists, its sibling will be the value of the variable S1. Since the selected element represents a top-level menu item it is also necessary to update menu order string 961 and so at step 2606 this is retrieved from menu order table 906. At step 2607 a new possible string is created by finding the element referring to ID1 and deleting it, if it exists, and inserting it before the element that includes the value of the variable ID3.

At this point, and following step 2604, a button is created that posts the possible update created either at step 2604 or at step 2605 to menus table 903, and the possible string, if it exists, to menu order table 906.

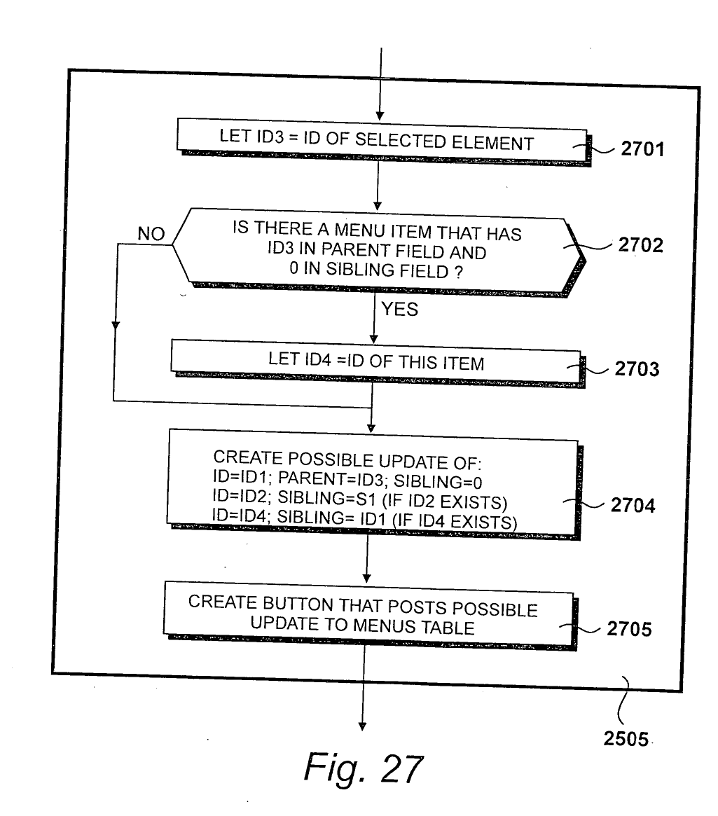

FIG. 27

FIG. 27 details step 2505 at which a button is created that inserts the selected menu item as a child of the menu item named in the first cell of the row. At step 2701 the value of the variable ID4 is set to be the ID of the selected element and at step 2702 a question is asked as to whether there is a menu item that has the value of the variable ID4 in the parent field 934 of menus table 903 and a value of zero in the sibling field 935. If this question is answered in the affirmative then at step 2703 the value of the variable ID5 is set to be the ID of this item. This item, if it is found, is the current eldest child of the menu item identified in the first cell of the row that will be supplanted by the selected menu item. Thus at this point, and if the question asked at step 2702 is answered in the negative, a possible update to menus table 903 is created. This contains the following information: for the menu item with ID 931 of the value of the variable ID1, its parent is the value of the variable ID4 and its sibling is zero; for the menu item that has ID 931 of the value of the variable ID2, if it exists, its sibling is the value of the variable S1; and for the menu item having ID 931 of the value of the variable ID5, if it exists its sibling is the value of the variable ID1. At step 2705 a button is created that posts this possible update to menus table 903.

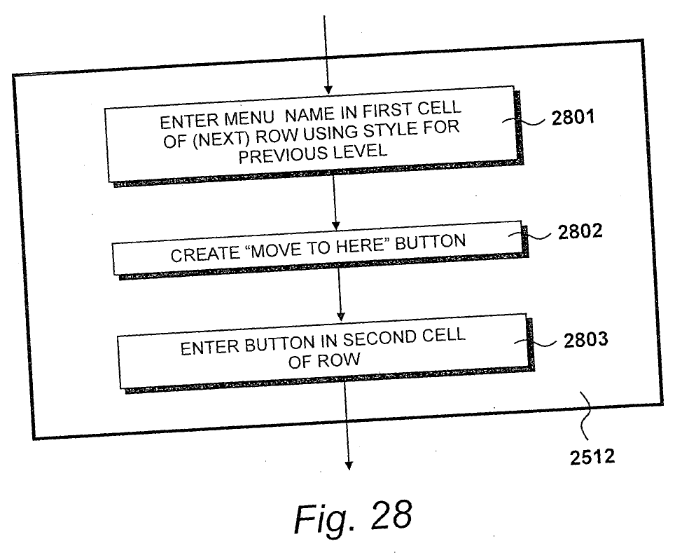

FIG. 28

FIG. 28 details step 2312 at which a “MOVEMENT” row is created for the selected menu item. One of these rows is created at the bottom of every family of sub-menus, in order to allow the menu item to be moved to this point. At step 2801 the menu name 932 of the selected menu item is entered in the first cell of the next row of the table, using an indent style appropriate for the previous level. At step 2802 a “MOVE TO HERE” button is created and at step 2803 this button is entered in the second cell of the row.

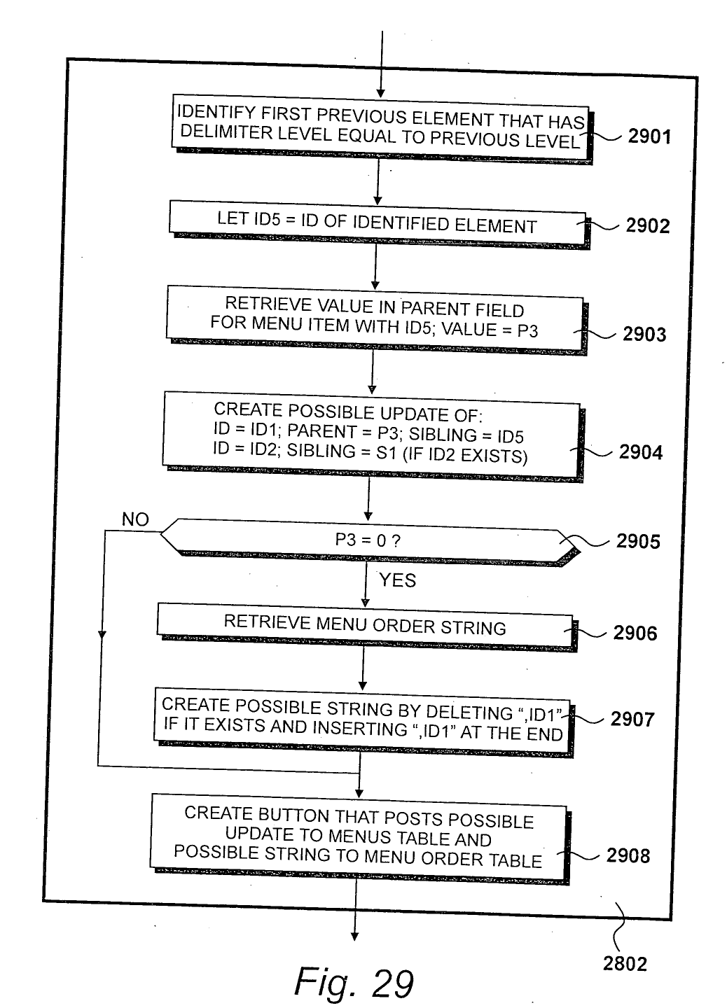

FIG. 29

FIG. 29 details step 2802 at which a button is created that moves the selected menu item to the position represented by the current row. At step 2901 the first element that comes before the currently selected element in the category string that has a delimiter level equal to the previous level is selected. This element represents the current last menu item or youngest sibling of the sub-menu family under consideration, and so at step 2902 the value of a variable ID6 is set to be the menu ID 931 of this identified element. At step 2903 menus table 903 is queried to retrieve the value in the parent field 934 for the entry that has menu ID 931 equal to the value of the variable ID6, and this retrieved value is set to be the value of a variable P3.

At step 2904 a possible update for menus table 903 is created as follows: for the item having ID 931 of the value of the variable ID1, the parent is set to be the value of the variable P3 and the sibling to be the value of the variable ID6, while for the menu item having an ID of ID 2, if it exists, its sibling is set to be the value of the variable S1. This has the effect of inserting the selected menu item as the last item in a family of sub-menus.

At step 2905 a question is asked as to whether the value of the variable P3 is equal to zero. If this is answered in the affirmative then the menu item having menu ID 931 of the value of the variable ID6 is a top-level menu item, which means that inserting the selected menu item into this position would also make the selected menu item a top-level menu item and thus menu order string 961 must be changed. Thus at step 2906 the menu order string is retrieved and at step 2907 a possible string is created by deleting an element representing the selected menu item if it exists, and inserting it at the end of the string.

At this point, and if the question asked at step 2905 is answered in the negative, a button is created that posts the possible update created at step 2904 to menus table 903 and the possible string created at step 2907 to menu order table 906.

FIG. 30

FIG. 30 shows an example of the viewable menu-placement webpage that might be created if the user was moving a menu item at step 1302. This step is not discussed in detail but involves the same menu-placement webpage as discussed with reference to FIGS. 20 to 29. The webpage is displayed using the interface of browser 603 on VDU 104. Table 3001 has been created and has fifteen rows. Referring back to FIG. 10, this represents a stage in the website design when only menu items 1009, 1010, 1012 and 1017 to 1023, plus a sub-menu item of menu item 1018, have been created, but the user has realised that he has created menu item 1018 in the wrong place. This place is indicated by row 3002. Row 3003 represents a submenu item of menu item 1018. Thus rows 3002 and 3003 are “INVALID” rows since they represent the current positions of the menu item to be moved and a menu item that is its descendants list.

This example uses the example menu structure shown in FIG. 21. Thus the category order string used to create the viewed webpage is,that shown at 2114.

Thus, for example, row 3004, representing the top-level menu item 1009, contains a “MOVE TO ABOVE” button, which would make menu item 1018 into the first top-level menu item, and a “MOVE TO CHILD” button, which would make menu item 1018 the first sub-menu item of menu item 1009, thus putting it in the position currently occupied by item 1012 at row 3005.

However, row 3006 does not represent an item that is currently in the menu structure but instead represents a possible position for menu item 1018, as do rows 3007, 3008 and 3009. Thus, for example, if the user selected button 3010 of row 3008 this action would move menu item 1018 to be the last submenu item of menu item 1009, which recourse to FIG. 10 shows to be the correct position.

Steps 1303 and 1304, at which the user may rename or delete menu items, are not described in full but involve scripts that allow the user to rename the values in fields 932 and 933 and delete records from menus table 903.

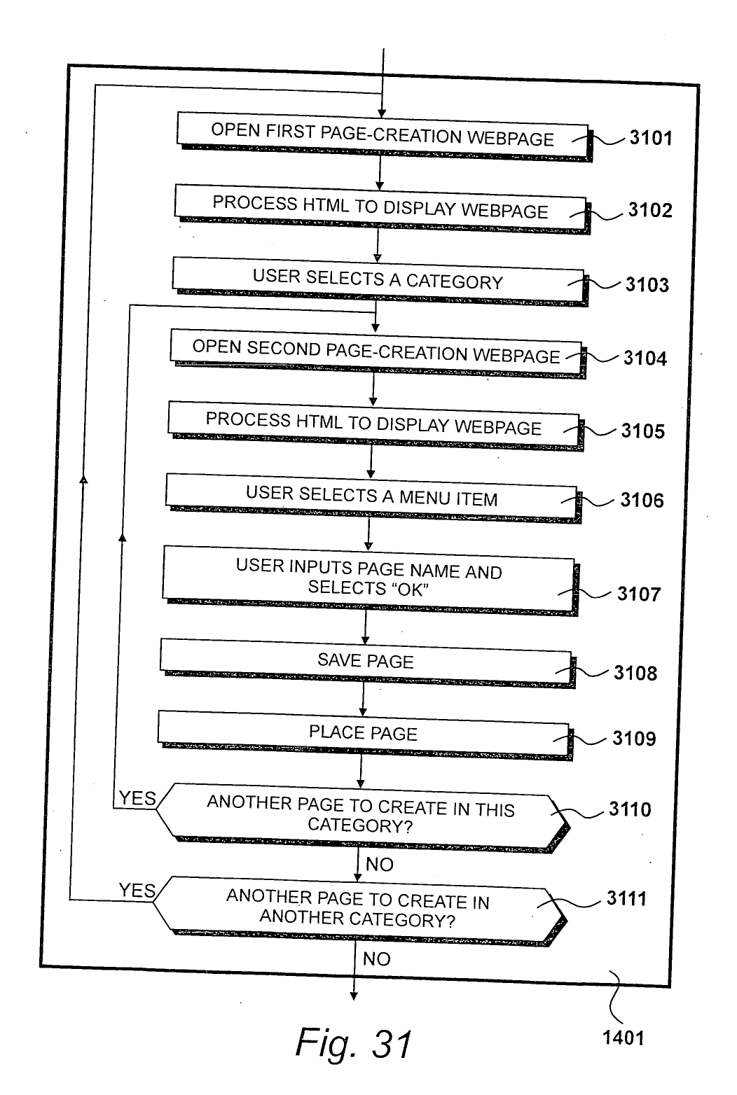

FIG. 31

FIG. 31 details step 1401 at which the user creates a page for the website he is designing. At step 3101 a first page-creation webpage, one of application webpages 606, is opened and at step 3102 the browser processes the HTML contained therein to display the page to the user on VDU 104. It is important at this stage to distinguish between application webpages 606, which provide an interface for the web design application, and the pages belonging to the website that are being designed. Herein application webpages 606 are referred to as webpages, whereas pages within the designed website are referred to simply as pages. This is a terminology offered for the purposes of clarity only and does not reflect any standard use. During the design stage the page exists only as one of content files 609, a record in pages table 904 and an element in a string in page order table 907. The page does not exist in a viewable form until the website is created at step 408.

The first page-creation webpage offers the user a list of categories to select from, which the user does at step 3103, following which the browser opens a second page-creation webpage at step 3104, and at step 3105 the browser processes the HTML contained therein to display the webpage to the user on VDU 104. This webpage displays the complete menu structure for the category selected at step 3103 and so at step 3106 the user selects the menu item. The page also provides an input box where the user provides a name for the page and a submit button which the user selects at step 3107.

At step 3108 the page thus named is saved and at step 3109 the page is placed within the menu item, since each menu item can have more than one page.

At step 3110 a question is asked as to whether there is another page to create in this category and if this question is answered in the affirmative control is returned to step 3104 and the second page-creation webpage is opened again. If it is answered in the negative then a second question is asked at step 3111 as to whether there is another page to create another category, whereupon an affirmative answer returns control to step 3101. If the question is answered in the negative then step 1401 is completed and at least one page has been created.

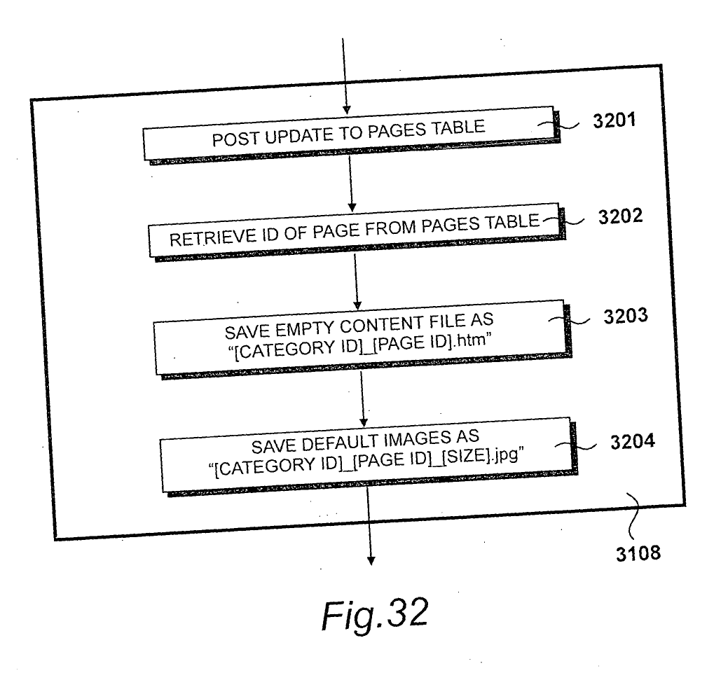

FIG. 32

FIG. 32 details step 3108 at which the created page is saved. At step 3201 pages table 904 is updated by inserting a new record that includes the page name inserted at step 3107, the ID 931 of the menu item selected at step 3106 and the category ID 911 of the category selected at step 3103. At step 3202 the page ID 941 of this new record is retrieved.

At step 3203 a default empty content file is saved, with the file name being the category ID 911 followed by an underscore followed by the page ID 941, with the extension “.htm”. Additionally, a default image is saved at various resolutions, each file name being the category ID 911 followed by an underscore followed by the page ID 941, followed by another underscore and the size in the percentage of the image, with the file extension “.jpg” (JPEG format). Typically six resolutions will be saved: ten percent of the full image, twenty percent, twenty-five percent, forty percent, fifty percent, and one hundred percent (i.e. the image at full resolution). These images of content files are used at various times, including when placing pages at step 3109 and previewing the website at step 1105. The default image used when a content file is empty is a large question mark.

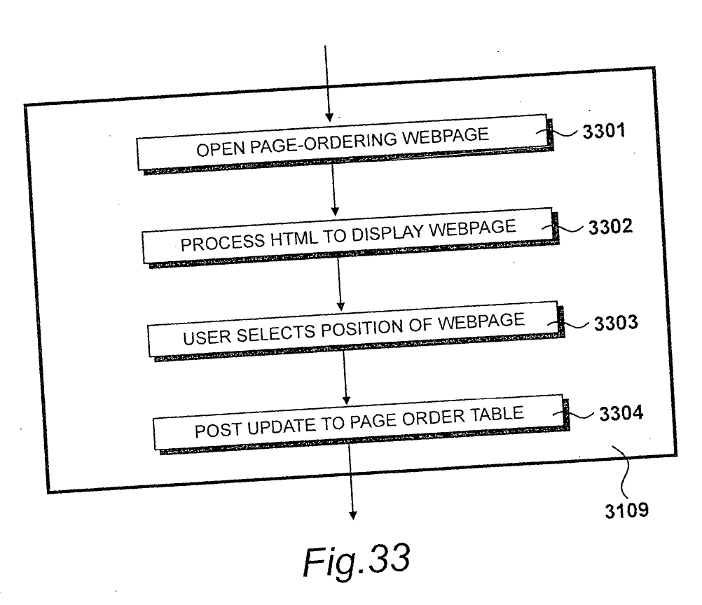

FIG. 33

FIG. 33 details step 3109 at which the newly-created page is placed within a menu item selected at step 3106. At step 3301 a page-ordering webpage, one of application webpages 606, is opened and at step 3302 the browser processes the HTML contained therein to display the webpage to the user on VDU 104. At step 3303 the user selects one of the possible positions presented on this webpage and at step 3304 the page order table 907 is updated with this information.

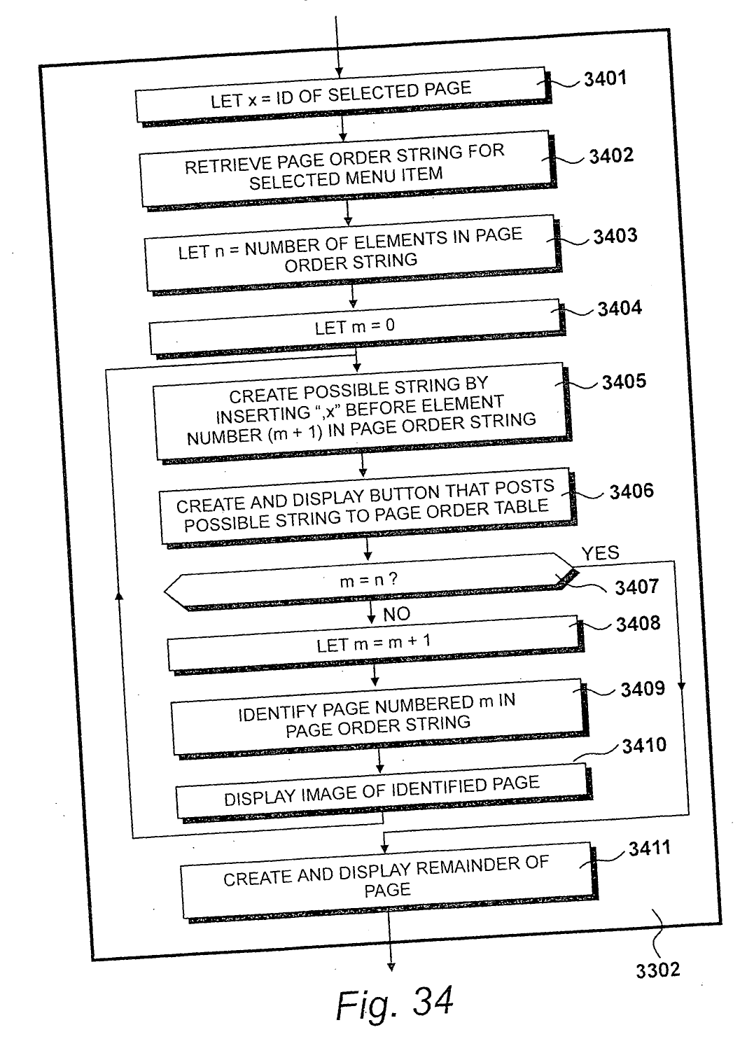

FIG. 34

FIG. 34 details step 3302 at which the page-ordering webpage is displayed on VDU 104. At step 3401 the value of a variable x is set to be the ID 941 of the new page, as retrieved at step 3202. At step 3402 the page order string 971 for the menu item selected at step 3106 is retrieved from page order table 907 and at step 3403 the value of a variable n is set to be the number of elements in this string. At step 3404 a counter variable m is set to be zero.

At step 3405 a possible new page order string is created by inserting an element consisting of a comma followed by the value of the variable x before the element numbered (m+1), and at step 4306 a button is created and displayed that posts this possible string to page order table 907. At step 3407 a question is asked as to whether the variable m is equal to n and if this question is answered in the negative then the variable m is incremented by 1 step 3408. At step 3409 the page ID 941 of the element numbered m in page order string 971 is identified and at step 3410 an image of this page is displayed. This is the image that has a resolution of twenty-five percent.

Control is then returned to step 3405 and the steps from 4305 to 4310 are iterated until the question asked at step 3407 is answered in the affirmative, to the effect that variable m is equal to n. At this point all the elements in the page order string have been identified and so at step 3411 the remainder of the page-ordering webpage is created and displayed.

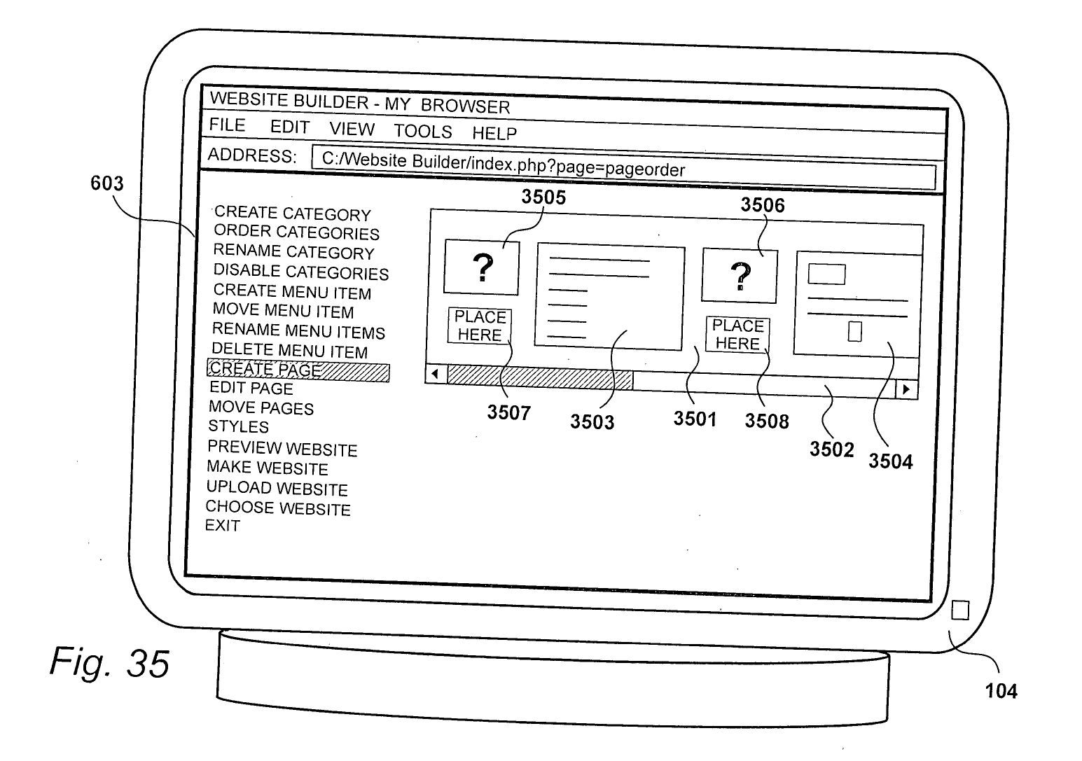

FIG. 35

FIG. 35 illustrates the page-ordering webpage displayed by browser 603 on VDU 104. The area created at steps 3401 to 3410 is shown as an iframe 3501, with scroll bar 3502 being available to show the rest of the frame. Images 3503 and 3504 are images of the first and second pages respectively in a selected menu item, while images 3505 and 3506 are images of the page being placed, along with the buttons 3507 and 3508 that will place the page in the positions indicated. Images 3505 and 3506 are question marks because this is the default image saved for an empty page.

This page-ordering webpage is also displayed when the user moves a page at step 1403, the only difference being that each button posts an additional string to page order database 907 that removes the page being moved from the page order string to which it currently belongs. This step will not be described in detail.

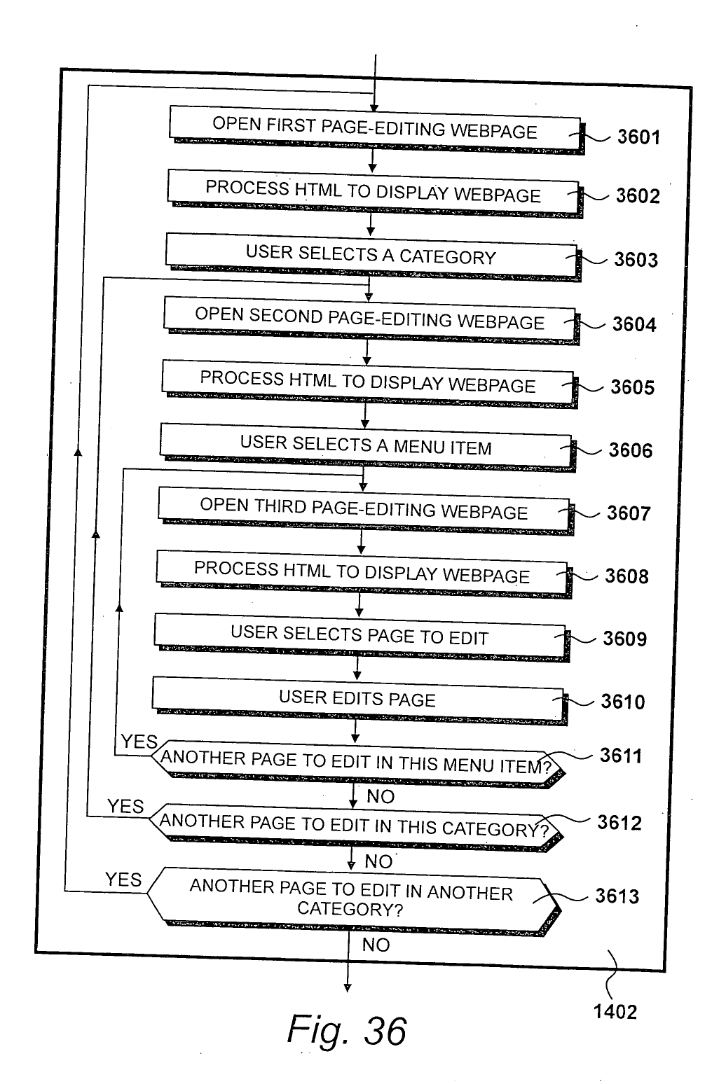

FIG. 36

FIG. 36 details step 1402 at which a page created at step 1401 is edited. At step 3601 a first page-editing webpage is opened, this being one of application webpages 606, and at step 3602 the browser processes the HTML contained therein to display the webpage to the user on VDU 104. This webpage displays the categories in the site and so at step 3603 the user selects one of these. At step 3604 a second page-editing webpage is opened, again one of application webpages 606, and at step 3605 the browser processes the HTML contained therein to display the webpage to the user on VDU 104. This webpage displays a list of all the menu items belonging to the category selected at step 3603 and so at step 3606 the user selects one of these.

At step 3607 a third page-editing webpage is opened and at step 3608 the browser processes the HTML contained therein to display the page to the user on VDU 104. This webpage displays images of all the pages in the menu item selected at step 3606, and so at step 3609 the user selects a page to edit and at step 3610 carries out editing on this page.

At step 3611 a question is asked as to whether the user wishes to edit another page belonging to this menu item and if this question is answered in the affirmative control is returned to step 3607 and the third page-editing webpage is opened again. If the question is answered in the negative then at step 3612 a second question is asked as to whether the user wishes to edit another page in this category and if this question is answered in the affirmative control is returned to step 3604 and the second page-editing webpage is opened again. If this question is also answered in the negative then a third question is asked at step 3613 as to whether the user wishes to edit another page in another category and if this question is answered in the affirmative control is returned to step 3601 and the first page-editing webpage is opened. If, however, it too is answered in the negative then step 1402 is concluded.

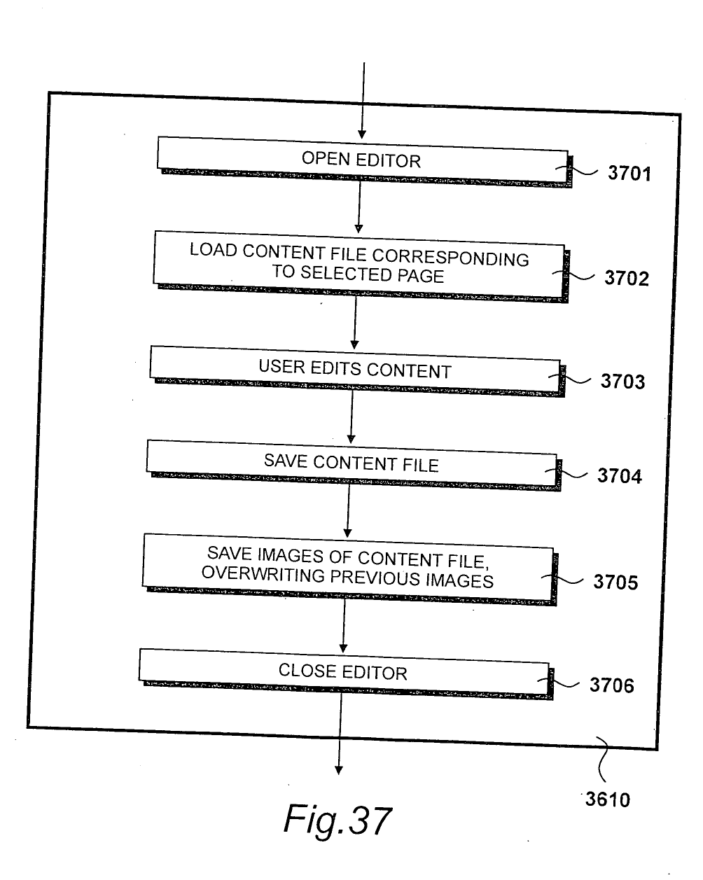

FIG. 37

FIG. 37 details step 3610 at which the user edits the page selected at step 3609. At step 3701 a Java-based rich text editor is opened and at step 3702 the content file corresponding to the selected page is loaded. This editor is used because it is cross-platform but other editors could be used. The content file has the filename of the category ID 921 selected at step 3603, followed by an underscore, followed by the page ID 941 selected at step 3609, with the suffix “.htm”. The HTML contained therein is processed by the editor and the content data is displayed to the user on the editor interface.

At step 3703 the user edits this content data. This is done by the user inputting text, images and other media files in the format in which it will be seen in the final viewable page. At step 3704 it is converted into HTML and saved. However, at any time the user may view the source code and change the content data in this way instead. In particular, he may input scripts in a language supported by his terminal 107 and host server 106. At step 3705 screen shots are taken of the content data and the images are saved at the various resolutions, overwriting the previous saved images. At step 3706 the editor is closed. The content data may include any kind of data which it is possible for a viewable page to contain. For example, in addition to simple text and images, it may include hyperlinks to other pages or websites, dynamic content, forms, scripts, audiovisual files, and so on.

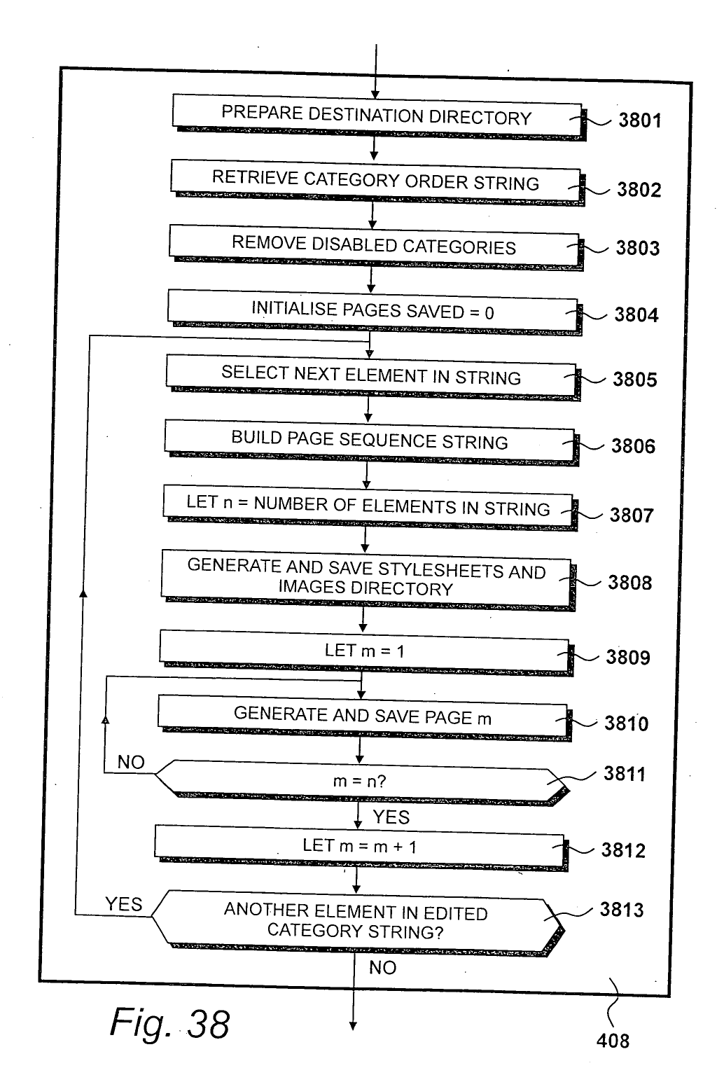

FIG. 38

FIG. 38 details step 408 at which the website is created (or published) by combining the separate navigation data 608 and content files 609 to generate pages. At step 3801 the destination directory on web terminal 107 is prepared to receive the pages that are to be generated. At step 3802 category order string 951 is retrieved from category order table 905 and at step 3803 it is edited by removing any element that corresponds to a category ID 921 that is disabled, as indicated by field 924. At step 3804 a variable PAGES_SAVED is initialised to be zero.

At step 3805 the first element in the category string 951 as edited at step 3803 is selected and at step 3806 a page sequence string is constructed for the category corresponding to this element. The page sequence string is a comma-delimited string that lists, in the order imposed by the menu structure, the page IDs 941 of the pages belonging to the menu items in the category. At step 3807 a variable n is set to be the number of elements in the page sequence string.

At step 3808 stylesheets are constructed and saved, along with any images required by the content files 609, in the destination directory. The stylesheets are saved in a directory called “css” and the images in a directory called “images”. The stylesheets are Cascading Style Sheets and are constructed from default stylesheets using the information in styles tables 908.

At step 3809 a counting variable m is initialised to be one and at step 3810 the page numbered m in the page sequence string is created. At step 3811 a question is asked as to whether the variable m is equal to the variable n and if this question is answered in the negative then m is incremented by one at step 3812 and control is returned to step 3810 where the next page in the sequence is created and saved.

Eventually the question asked at step 3811 will be answered in the negative, indicating that all the pages in the category have been generated. A question is thus asked at step 3813 as to whether there is another element in the edited category order string. If this question is answered in the affirmative then control is returned to step 3805 and the next element is selected. Alternatively, if it is answered in the negative, step 408 is completed. All the pages in the website have now been generated, thus completing the publishing of the website which may now be uploaded to host server 106 at step 409.

Thus a method is carried out of generating a plurality of pages suitable for viewing over the internet 105 with hyperlinks interconnecting said pages, wherein each page includes a plurality of hyperlinks arranged to represent a portion of a hierarchical navigation system, comprising the steps of storing a plurality of content files 609 for containing content data, creating and storing a logical and editable representation of said navigation structure in the form of navigation data 608 and processing the content files in combination with said navigation data to produce a plurality of pages each representing said navigation structure, such that when displayed by a browser a content area derived from said content data is displayed with components of said navigation structure within the boundary of a viewable page.

Step 1105, at which the website design may be previewed, does not involve creating pages in this way. Step 1105 is not set out in full, but a script is run that creates a dynamic website, where each page is created on the fly but has the formatting that will be applied to the finished website. It is the full-size screenshot images saved at step 3705 that are displayed in the content area of the dynamic page, rather than the content files themselves.

Step 408, as described in FIG. 38, is actually the process of caching the dynamic page for a plurality of category IDs 921 and page IDs 941. The destination directory can then be considered as a cache of pages. It will therefore be understood that in other embodiments (not shown) the cached pages need not be static as herein described, since partially-dynamic pages can also be cached. However the overall process of combining navigation data with content data to create a navigation structure on a cached page still occurs in these embodiments.

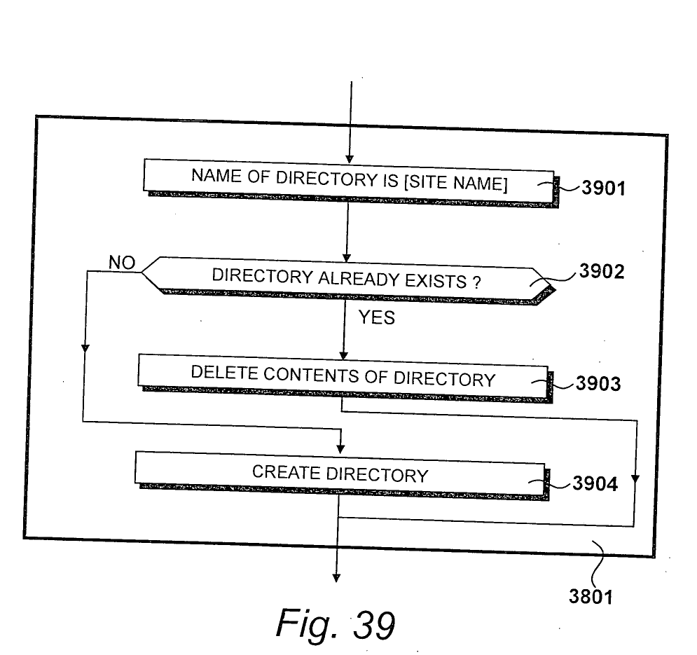

FIG. 39

FIG. 39 details step 3801 at which the destination directory is prepared. At step 3901 the name of the directory is identified as the name 912 corresponding to the site ID 911 of the website design. At step 3902 a question is asked as to whether this directory already exists and if it is answered in the affirmative then at step 3903 the contents of the directory are deleted. If is answered in the negative then the directory is created.

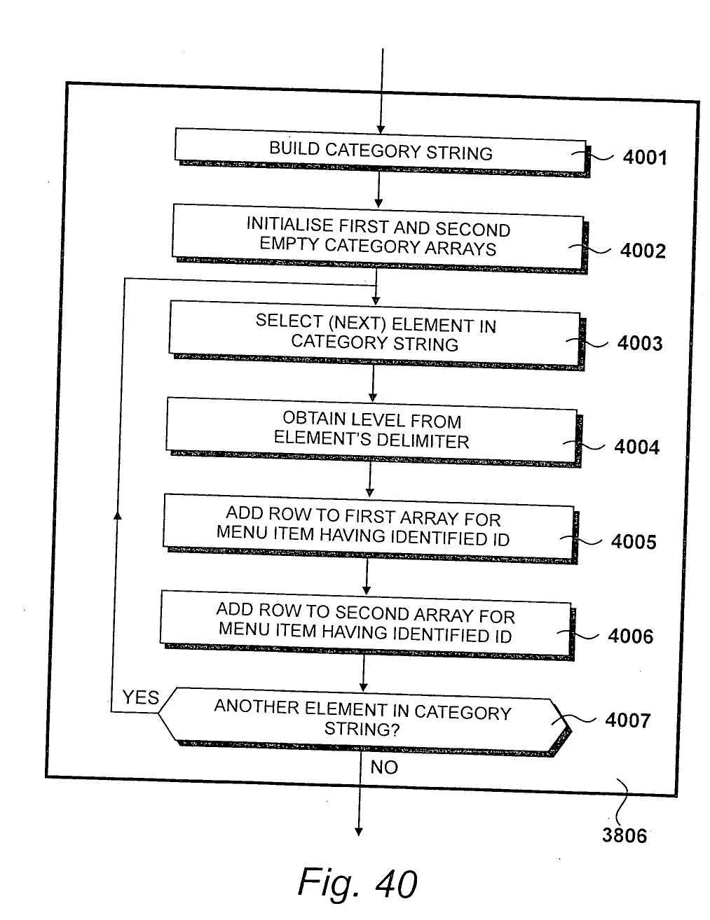

FIG. 40

FIG. 40 details step 3806 at which the page sequence string is created. At step 4001 the category string, an example of which was shown at 2112 in FIG. 21, is created, just as at step 1902 detailed in FIG. 20. At step 4002 a first category array and a second category array are both initialised to be empty.

At step 4003 the first element in the category string is selected and at step 4004 the level of the element is obtained from its delimiter, just as at step 2203. At step 4005 a row is added to the first category array created at step 4002 for the menu item ID 931 contained in the selected element, while at step 4006 a row is added to the second category array for this menu ID.

At step 4007 a question is asked as to whether there is another element in the category string and if this question is answered in the affirmative then control is returned to step 4003 and the next element is selected. If it is answered in the negative then the arrays have been populated. The page sequence string is obtained from the first category array at step 4008 and so step 3806 is completed.

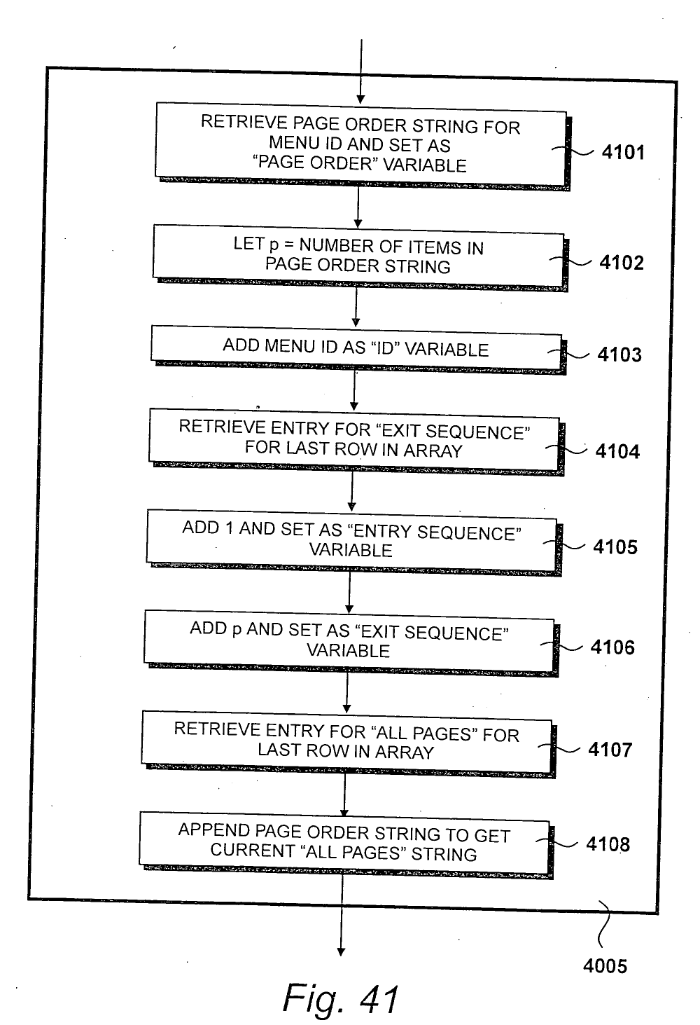

FIG. 41

FIG. 41 details step 4005 at which a row is added to the first category array for the menu item ID 931 corresponding to the selected element. The first category array includes five variables: ID, Which corresponds to a menu item ID 931; ENTRY SEQUENCE, which gives the number in the eventual page sequence string of the first page belonging to the menu item, and EXIT SEQUENCE, which gives the number of the last page; PAGE ORDER, which is the page order string 971 for the menu item as stored in page order table 907; and ALL PAGES, which is a cumulative string which creates the page sequence string.

When the page sequence string has been created, the values for ENTRY SEQUENCE and EXIT SEQUENCE give the numbers of the elements in the string that correspond to a menu item's pages. For example, if a menu item were the first menu item in a category string and contained three pages its ENTRY SEQUENCE value would be one and its EXIT SEQUENCE value would be three. If the second menu item contained two pages its values would be four and five respectively. A distinction is drawn between the page ID 941, which is set when the page is created by the database application and cannot be changed, and the page number, which is the position of a page in the page sequence string.

Thus at step 4101 the menu ID for the selected element is added to the array to create a new row. At step 4102 page order string 971 is retrieved for the menu ID 931 corresponding to the selected element and entered in the array as the PAGE ORDER string. At step 4103 a variable p is set to be the number of items in the string. At step 4104 the last value for the variable EXIT SEQUENCE, that is the value for the previous row, is retrieved. At step 4105 this value is incremented by one and added to the array as the ENTRY SEQUENCE value. At step 4106 the variable p is added to the value retrieved at step 4104 and added to the array as the EXIT SEQUENCE value.

At step 4107 the last entry for ALL PAGES, that is the value for the previous row, is retrieved and at step 4108 the current page order string is appended to it and stored in as the value for ALL PAGES for the current row.

Thus when step 4005 has been iterated for every element in the category string created at step 4001 the first category array contains a row for every element, and the entry for ALL PAGES for the final row is the page sequence string obtained at step 4008.

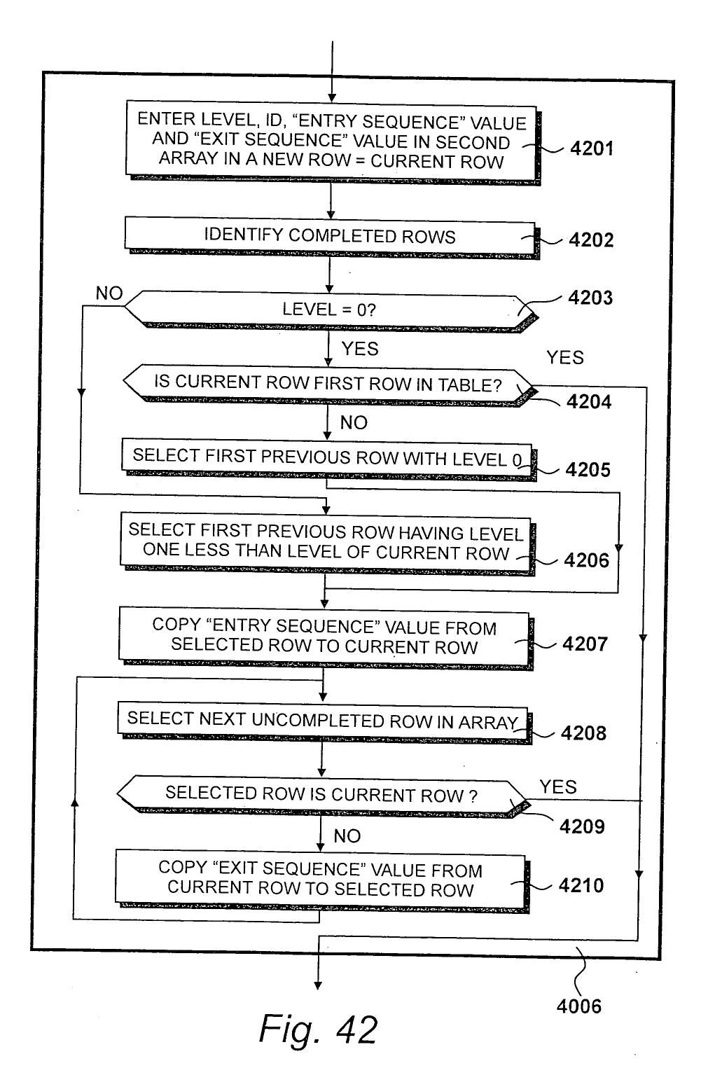

FIG. 42

FIG. 42 details step 4006 at which the second category array is populated. This category array includes five variables: COMPLETE, which is takes Boolean values indicating whether or not the row is complete; LEVEL, which corresponds to the level of the selected element as indicated by its delimiter; ID, which corresponds to the menu ID 931 of the selected element; and ENTRY SEQUENCE and EXIT SEQUENCE, which are similar to these variables in the first category array but give the page numbers between which the menu item should be visible in the webpages. In this application, each page belonging to a menu item has part of the menu structure on the left-hand side. The menu items belonging to this partial menu structure are called visible menu items. Top-level menu items are always visible. Sub-menu items are visible if they are one of three things: the menu item that contains the open webpage, in which case it is indicated as such by highlighting; a menu item of which the highlighted menu item is a direct descendant; or a sibling of another visible menu item. Each visible menu item on a webpage is a hyperlink to the first page of that menu item, which will contain a different menu structure because the sub-menus of the menu item clicked on will be visible. Thus the impression is given of a dynamic menu structure. Whether or not a menu item is visible is decided by the ENTRY SEQUENCE and EXIT SEQUENCE values in the second category array. If a page number is equal to or between these values for a particular ID then the menu item having that ID is visible for that page.

Thus at step 4201 the ID, ENTRY SEQUENCE and EXIT SEQUENCE values from the new row in the first category array are copied to the same positions in the second category array, the level identified at step 4005 is entered as the value for the variable LEVEL and the value COMPLETE is initialised as false. This row thus created is considered to be the current row. At step 4202 completed rows, for which the variable COMPLETE is true, are identified.

At step 4203 a question is asked as to whether the current value of LEVEL is zero. If this question is answered in the affirmative a further question is asked at step 4204 as to whether the current row is the first row in the table. If this question is answered in the affirmative then there is no further action to take on this iteration and step 4006 is concluded. If, however, it is answered in the negative then the first row previous to the current row which also has level zero is selected at step 4205. If the question asked at step 4203 is answered in the negative then the first row previous to the current row which has a level one less than the current level is selected at step 4206. Thus if the current row relates to a top-level menu item the row relating to the preceding top-level item is selected, while if is not then the row relating to its parent menu item is selected.

In either case, at step 4207 the value for ENTRY SEQUENCE for the selected row is copied to be the value of the same variable for the current row. This ensures that a top-level menu item is always visible, and ensures that a sub-menu item is visible if its parent is visible.

At step 4208 the first uncompleted row in the second category table is selected, that is to say the first row having the value “false” for its COMPLETED variable, and at step 4209 a question is asked as to whether this selected row is the current row. If this question is answered in the affirmative then step 4006 is completed. Alternatively, if it is answered in the negative then the value for the EXIT SEQUENCE variable in the current row is copied to be the value of the same variable in the selected row at step 4210. This ensures that a menu item is always visible if one of its sub-menu items is visible.

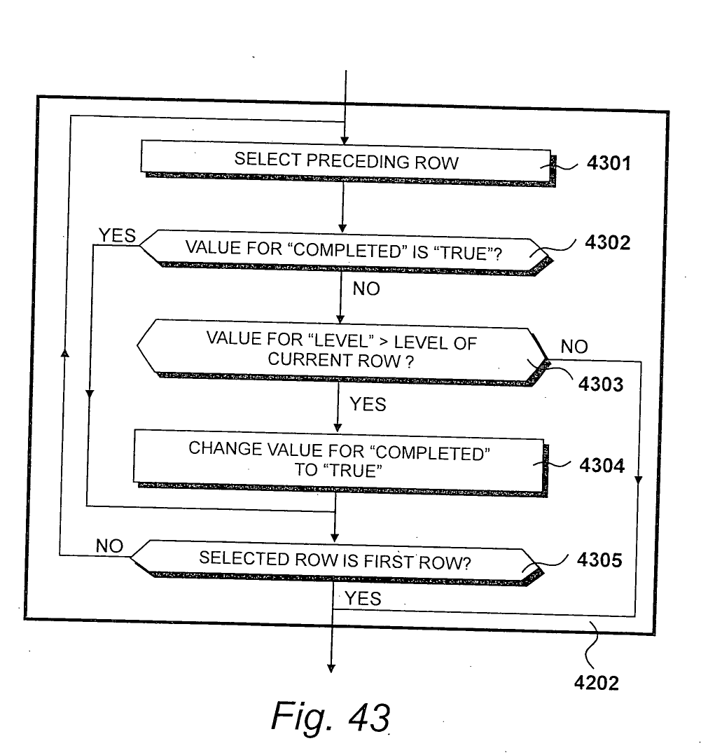

Following step 4210 control is returned to step 4208 and the next uncompleted row is selected. Eventually the question asked at step 4209 will be answered in the affirmative and step 4006 is complete for this iteration. FIG. 43

FIG. 43 details step 4202 at which completed rows are identified. At step 4301 the row immediately preceding the current one is selected and at step 4302 a question is asked as to whether its value for COMPLETED is “true”. If this question is answered in the negative then at step 4303 a further question is asked as to whether the its value for the variable LEVEL is less than the same value for the current row. If this question is answered in the affirmative then the value of the variable COMPLETED for the selected row is changed to “true”, since if the current row is of a lower level than the selected row then all the menu items considered to be in the “family” of the menu item for the selected row have been considered and so its values for the ENTRY SEQUENCE and EXIT SEQUENCE should not now be changed. A question is then asked at step 4304 as to whether the selected row is the first row, and if this question is answered in the negative then control is returned to step 4301 and the row preceding the selected row is itself selected. If this question is answered in the affirmative, or the question asked at step 4303 is answered in the negative, then step 4202 is concluded, either because there are no more rows to examine (in the first instance) or because all the completed rows have been found (in the second instance).

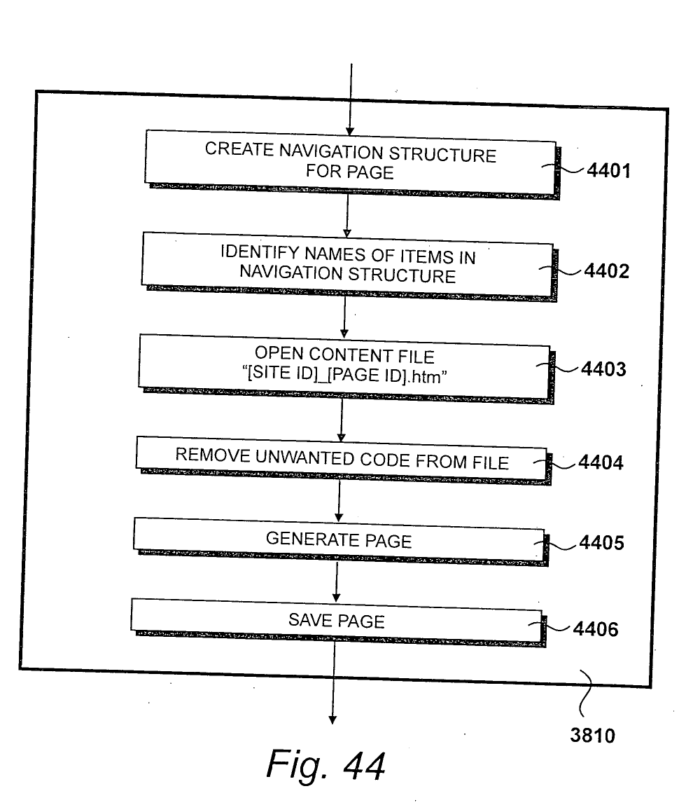

FIG. 44

FIG. 44 details step 3810, at which the page numbered m is generated and saved. At this point the only known variables are the site ID 911, the category ID 921 and the page number m. The category string and page sequence string have been built and the first and second category arrays populated.

At step 4401 a navigation structure is created for page m and at step 4402 the names of certain items in that structure are identified from database 608. At step 4402 the content file for this page is opened, which is identified by the site ID 911, followed by an underscore and the page ID 941 (which has been identified during step 4401), with the file extension “.htm”. At step 4403 unwanted code is removed from this file to create content data. HTML is added to each content file in order that it will display on the browser and so this is removed. Additionally, various references to application scripts 607 are removed. However, any code that the user has input and references to his own scripts are not removed.

At step 4404 a page is generated by combining the navigation structure created at step 4401 and the content data created at step 4403, and at step 4405 the page is saved.

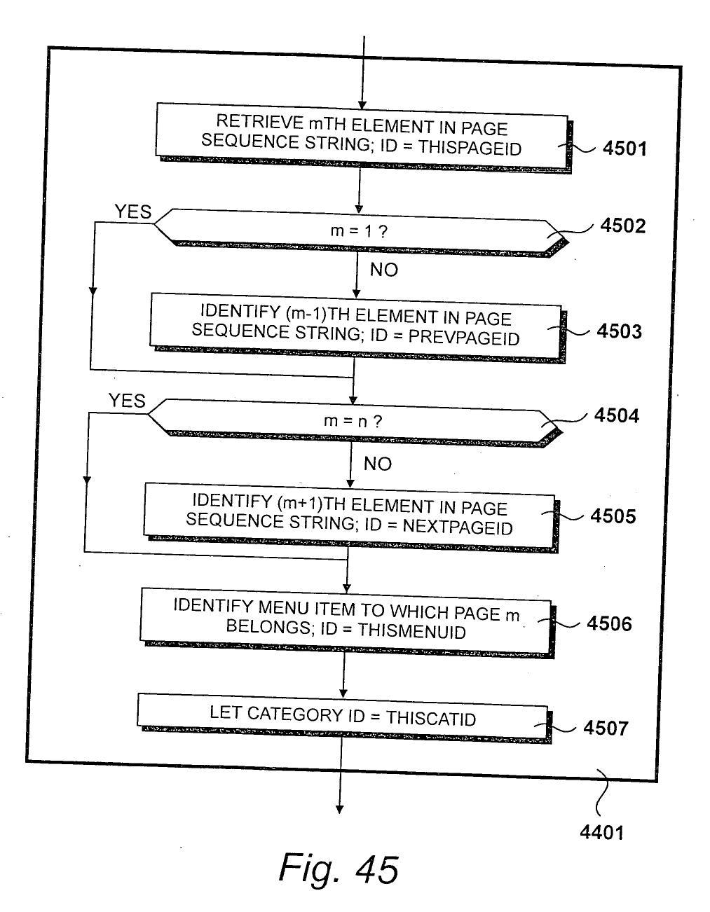

FIG. 45

FIG. 45 details step 4401 at which the navigation structure for the page is created. At step 4501 the element numbered m in the page sequence string is identified and a variable THISPAGEID is set to be the page ID 941 contained in that variable. Thus THISPAGEID is the page ID 941 of the page numbered m, that is the page being created. At step 4502 a question is asked as to whether m is equal to one. If this question is answered in the negative then at step 4503 the element numbered (m−1) in the page sequence string is identified and a variable PREVPAGEID is set to be the page ID 941 contained in that element—that is, the page ID of the page immediately previous to the one being created. If, however, if the question asked at step 4502 is answered in the affirmative then there is no previous page and step 4503 is bypassed.

Similarly, at step 4504 a question is asked as to whether the current value of m is equal to the variable n, which was set at step 3807 to be the number of elements in the page sequence string. If this question is answered in the negative then at step 4505 the element numbered (m+1) in the page sequence string is identified and a variable NEXTPAGEID is set to be the page ID 941 contained in that element—that is, the page ID of the page immediately following the one being created. If, however, the question asked at step 4504 is answered in the affirmative then there is no next page and step 4505 is bypassed.

At step 4506 the menu item ID 921 of the menu item to which the page belongs is identified and set as the variable THISMENUID. Similarly, at step 4507 the category ID, which is identified from the element in the category order string selected at step 4003, is set to be the value of a variable THISCATID. Step 4401 is then complete, with the IDs of the page under creation, its previous and next pages and the menu and category to which it belongs identified.

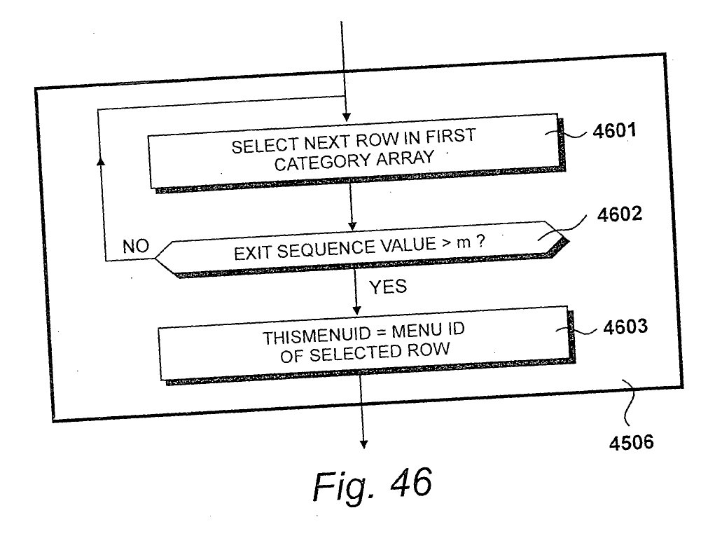

FIG. 46

FIG. 46 details step 4506, at which the variable THISMENUID is set. At step 4601 the first row in the first category array is selected and at step 4602 a question is asked as to whether the value of the EXIT SEQUENCE variable in that row is less than m, the number of the page being created. If this question is answered in the affirmative then control is returned to step 4601 and the next row is selected. If, however, it is answered in the negative then the menu item containing the page numbered m has been discovered and so the value of the variable ID for the selected row is set as the value of the variable THISMENUID.

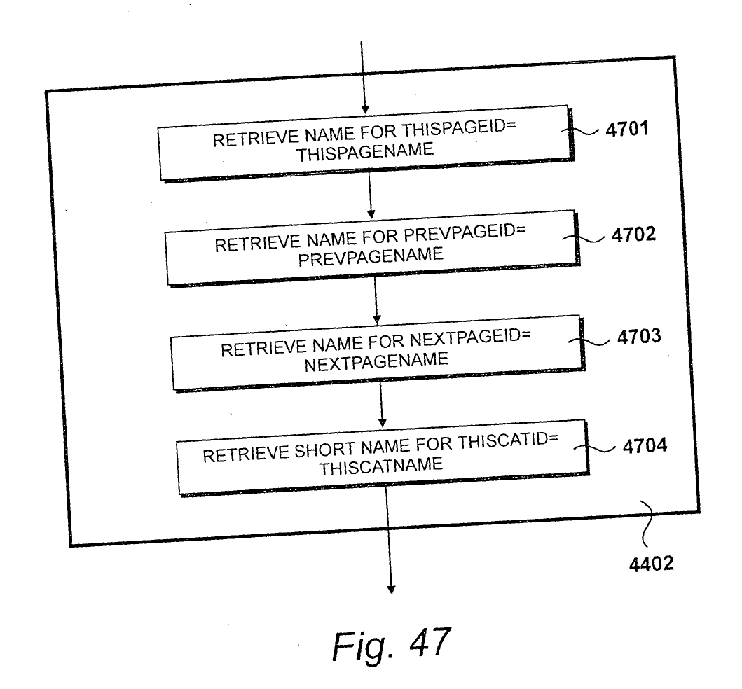

FIG. 47

FIG. 47 details step 4402 at which the names for the various IDs retrieved at step 4401 are identified. At step 4701 the name 942 corresponding to the page ID 941 that is the value of variable THISPAGEID is retrieved from pages table 904 and set to be the value of variable THISPAGENAME. Similarly, at step 4702 the name 942 corresponding to the page ID 941 that is the value of variable PREVPAGEID is retrieved from pages table 904 and set to be the value of variable PREVPAGENAME, and at step 4703 the name 942 corresponding to the page ID 941 that is the value of variable NEXTPAGEID is retrieved from pages table 904 and set to be the value of variable NEXTPAGENAME.

At step 4704 the short name 923 corresponding to the category ID 921 that is the value of variable THISCATID is retrieved from categories table 902 and set to be the value of variable THISCATNAME.

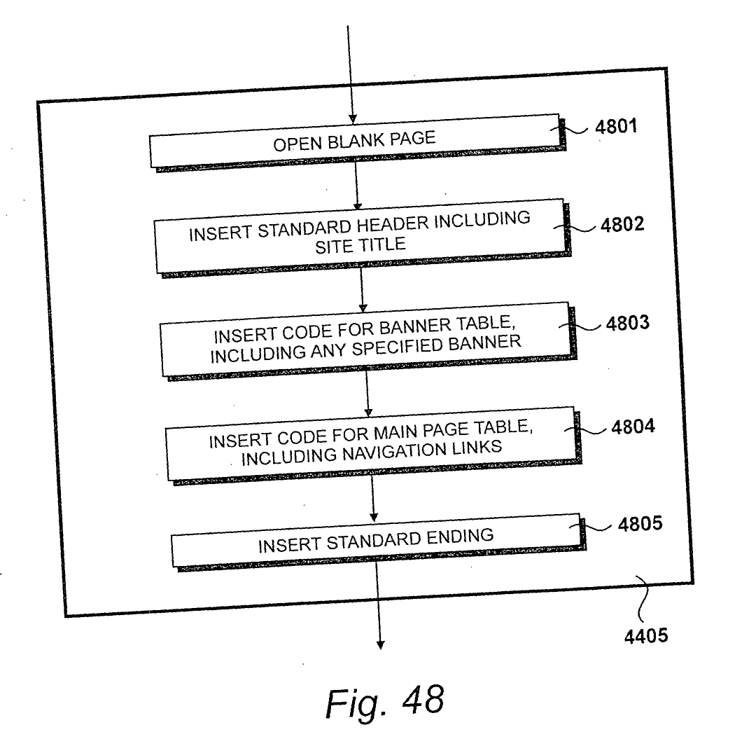

FIG. 48

FIG. 48 details step 4405 at which the page is generated by combining navigation data and content data. At step 4801 a blank page is opened in a text editor. This can be any editor since the markup language, together with any embedded scripting language, that defines a webpage is not formatted.

At step 4802 a standard header is inserted. This includes the title of the site, as given by name 912, script defining the stylesheets to use, scripts regarding caching and anything else that is necessary, plus the opening tag for the body.

At step 4803 the code for a table that defines a banner along the top of the webpage is inserted. This includes any image or text that the user has specified in the style settings.

At step 4804 the code for another table that contains the content area of the page is inserted, including all the hyperlinks necessary for navigating the website, and at step 4805 a standard ending to the page is inserted, usually simply including the closing body and HTML tags.

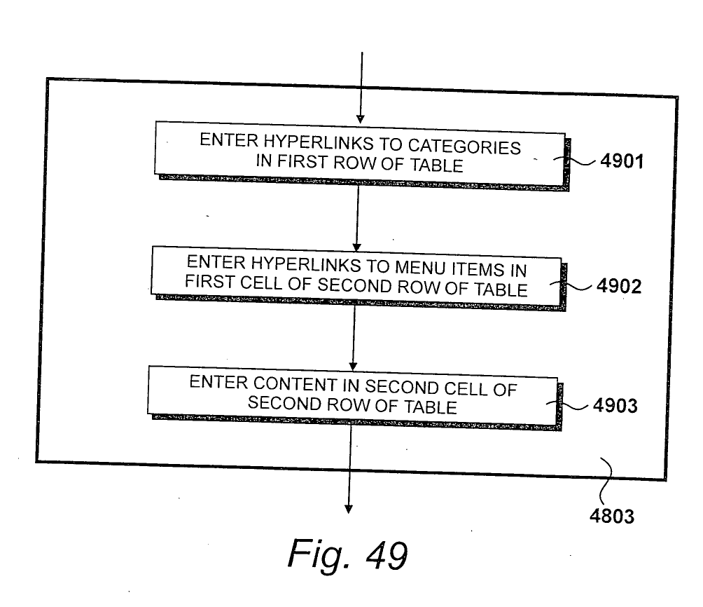

FIG. 49

FIG. 49 details step 4803, at which the code for the content area of the page is inserted. At step 4901 hyperlinks to the categories in the site are inserted in the first row of a table, and at step 4902 hyperlinks to the visible menu items are inserted in the first cell of second row of the table. At step 4903 the content data obtained at step 4403, along with hyperlinks to the previous and next pages, are inserted in the second cell of this row.

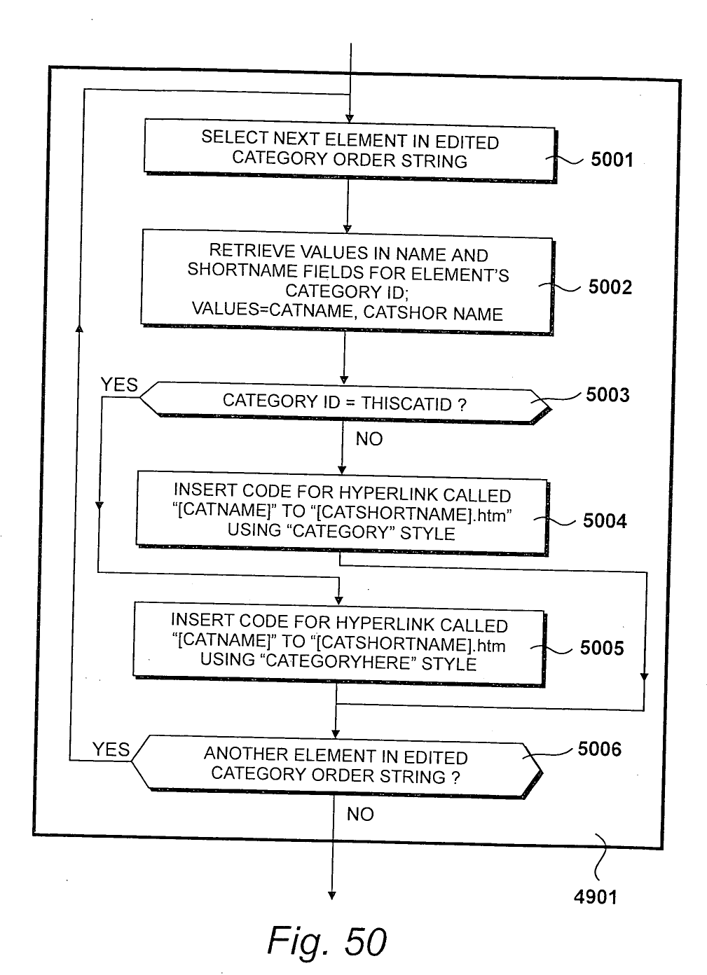

FIG. 50

FIG. 50 details step 4901, at which code for the hyperlinks to the categories is inserted. At step 5001 the first element in the edited category string obtained at step 3803 is selected and at step 5002 the name 922 and short name 923 corresponding to the category ID 921 contained in the element are retrieved from categories table 902; these are set to be the values of variables CATNAME and CATSHORTNAME respectively.

At step 5003 a question is asked as to whether the category ID 921 of the selected element is the same as the value of the variable THISCATID set at step 4507. If this question is answered in the negative then at step 5004 code is inserted for a hyperlink called by the value of the variable CATNAME, which links to the file having the name of the value of the variable CATSHORTNAME with the file extension “.htm”. The style used for this hyperlink is called “CATEGORY”. This is a style defined by the stylesheet used if the question asked at step 5003 is answered in the affirmative then the selected category is the one that the page being created belongs to, which means that the hyperlink should be highlighted to show this. Thus at step 5005 the same code is inserted but using the style “CATEGORYHERE”. This style has different formatting from the style “CATEGORY” and so provides highlighting for the hyperlink. The exact nature of the difference is entirely up to the web designer, and indeed there could be no difference at all. However, usually the colour of the background or of the text is changed.

At step 5006 a question is asked as to whether there is another element in the edited category order string, and therefore another hyperlink to consider. If this question is answered in the affirmative then control is returned to step 5001 and the next element is selected. If it is answered in the negative then step 4901 is concluded.

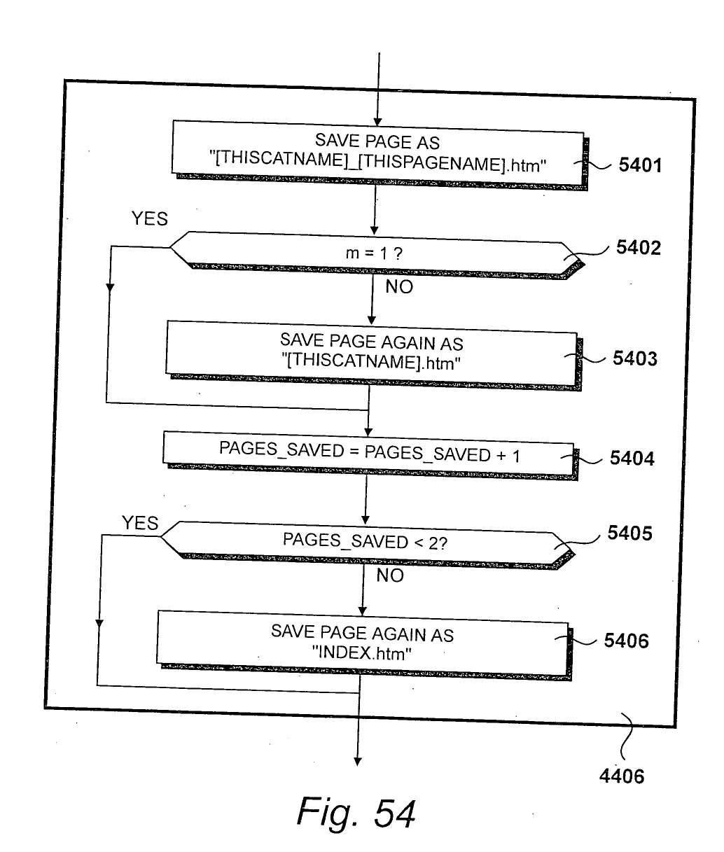

As an example of the code for the hyperlinks, referring back to the example in FIG. 10 suppose a link to category 1001 were being created. This category has the name COMPANY and the short name COMP. The hyperlink would display to the user as the word COMPANY and would link to a file called “comp.htm”. The creation of such a file will be described further with reference to FIG. 54, but it is the first page in category 1001, that is to say the first page in menu item 1004.

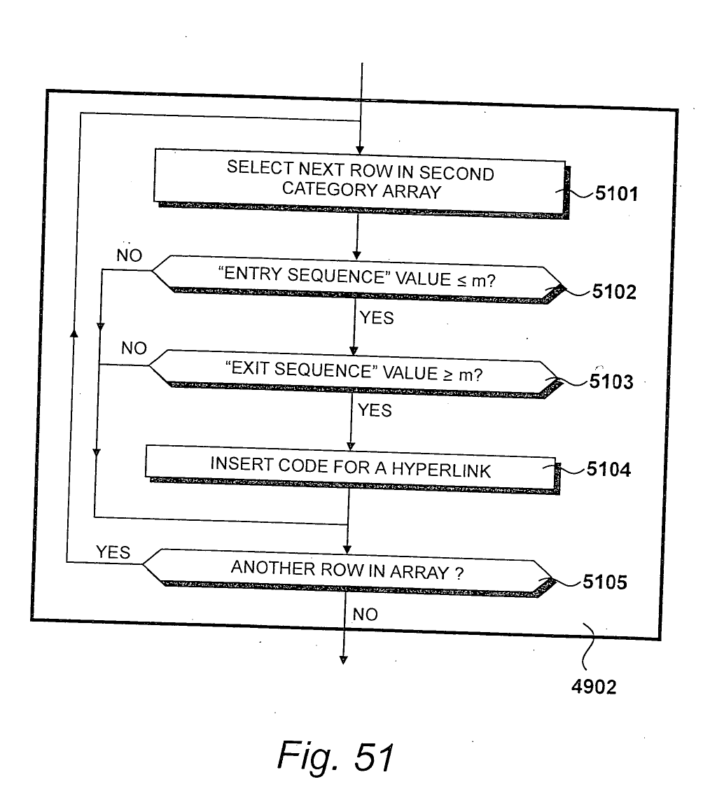

FIG. 51

FIG. 51 details step 4902 at which code for the hyperlinks to visible menu items is created. At step 5101 the first row in the second categories array is selected and at step 5102 a question is asked as to whether the value of the variable ENTRY SEQUENCE for this row is less than or equal to the page number m. If this question is answered in the affirmative then a second question is asked at step 5103 as to whether the value of the variable EXIT SEQUENCE is greater than or equal to m. If this question is also answered in the affirmative then the page number m is contained within the range defined by the two variables, and so the menu item corresponding to the selected row should be visible on this page. Thus at step 5104 code is inserted defining a hyperlink.

At this point, and if either of the questions asked at steps 5102 or 5103 are answered in the negative, a further question is asked at step 5105 as to whether there is another row in the second category array. If this question is answered in the affirmative then control is returned to step 5101 and the next row is selected. If it is answered in the negative then all the visible menu item have been considered and step 4902 is concluded.

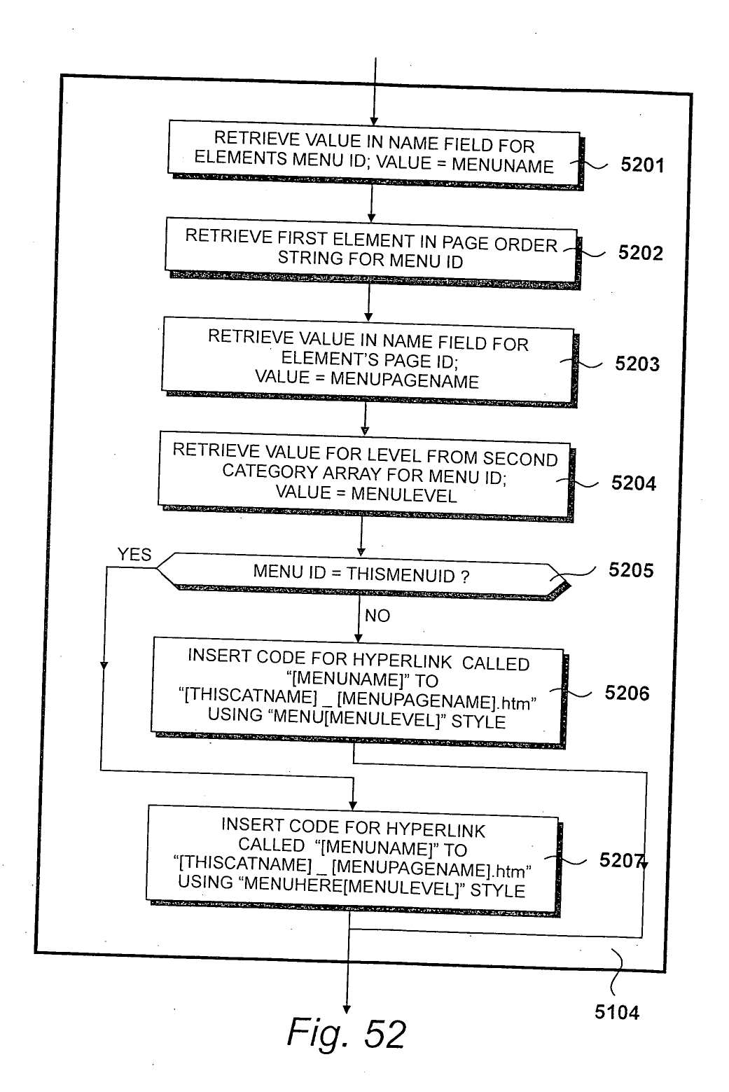

FIG. 52

FIG. 52 details step 5104 at which code for a hyperlink is inserted. At step 5201 the name 932 corresponding to the menu item ID 931 of the row selected at step 5101 is retrieved from menus table 902 and set to be the value of a variable MENUNAME. At step 5202 the first element in the page order string 971 corresponding to the same menu item ID 931 is retrieved from page order table 907, and at step 5203 the name 942 corresponding to the page ID 941 contained in this element is retrieved from pages table 904 and set to be the value of a variable MENUPAGENAME. Lastly, at step 5204, the value of the variable LEVEL is retrieved from the row of the second category array that was selected at step 5101 and set to be the value of a variable MENULEVEL.

These variables having been set, the code for the hyperlinks can be created. At step 5205 a question is asked as to whether the menu ID 931 of the row selected at step 5101 is equal to the value of the variable THISMENUID, as set at step 4506. If this question is answered in the negative then at step 5206 code is inserted for a hyperlink called by the value of the variable MENUNAME, which links to the file having the name of the value of the variable CATSHORTNAME, followed by an underscore, followed by the value of the variable MENUPAGENAME, with the file extension “.htm”. The style used for this hyperlink is called “MENU” plus the value of the variable LEVEL. Ten menu styles are defined by the stylesheet used, one for each level of the menu structure. If the question asked at step 5205 is answered in the affirmative then the menu item for which the hyperlink is being created is the one that the page belongs to, which means that the hyperlink should be highlighted to show this. Thus at step 5005 the same code is inserted but using the style called “MENUHERE” plus the value of the variable LEVEL.

Thus, for example, referring back to FIG. 10, if a page were being created that belonged to menu item 1024 then the visible menu items would be top-level menu items 1009 to 1011, first-level sub-menu items 1012 to 1018, second-level sub-menu items 1019 to 1021, third-level sub-menu items 1022 and 1023, and fourth-level sub-menu items 1024 and 1025. The sub-menu structures of items 1010 and 1011 would not be visible, nor any of the sub-menu structures that are implied but not shown in FIG. 10. The menu structures of categories 1001 and 1003 would not visible because they belong to a different category.

Thus, for example, a hyperlink to menu item 1012 is actually a link to the first page belonging to that menu item. If, for example, the name 942 of the page were “MIXERS1” and the short name of category 1002 were “PROD”, then the hyperlink would display to the user as the word MIXERS and would link to a file called “prod_mixers1.htm”. The hyperlink would be formatted using the style “MENU 1”, as defined in the stylesheet.

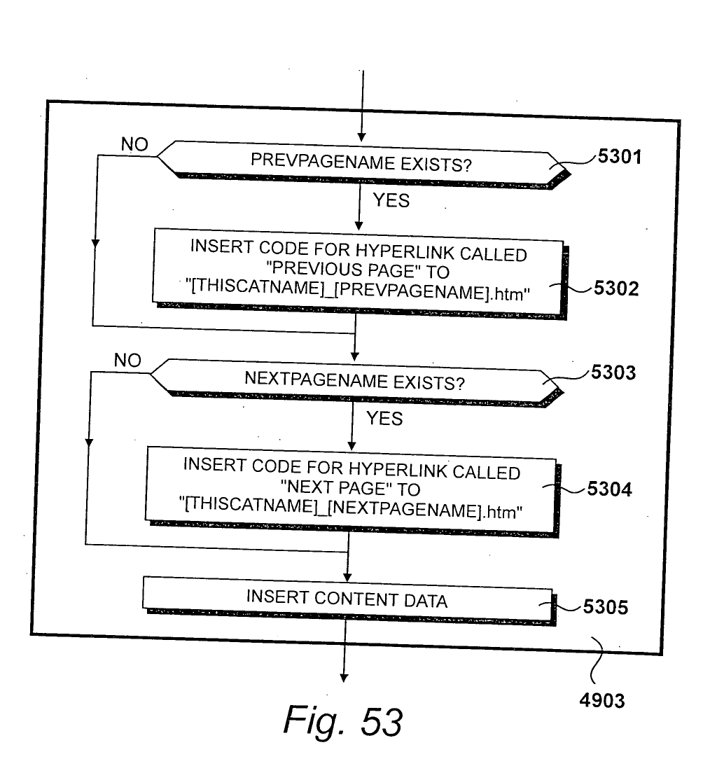

FIG. 53

FIG. 53 details step 4903 at which the content data is entered into the HTML page. At step 5301 a question is asked as to whether the variable PREVPAGENAME has been assigned a value, and if this question is answered in the affirmative then at step 5302 code defining a hyperlink called “Previous Page” is inserted, the hyperlink linking to a page called by the value of the variable THISCATNAME, followed by an underscore, followed by the value of the variable PREVPAGENAME, with the file extension “.htm”. If the question asked at step 5301 is answered in the negative then the page is the first in the category and so no “Previous Page” hyperlink can be created and step 5302 is bypassed.

Similarly, at step 5303 a question is asked as to whether the variable NEXTPAGENAME has been assigned a value, and if this question is answered in the affirmative then at step 5304 code defining a hyperlink called “Next Page” is inserted, the hyperlink linking to a page called by the value of the variable THISCATNAME, followed by an underscore, followed by the value of the variable NEXTPAGENAME, with the file extension “.htm”. If the question asked at step 5303 is answered in the negative then the page is the last in the category and so no “Next Page” hyperlink can be created and step 5304 is bypassed.

Thus, continuing the example started with respect to FIG. 52, the “Next Page” hyperlink on the page called “prod_mixers1.htm”, belonging to the menu item 1012 could be to “prod_mixers2.htm”. However, its “Previous Page” hyperlink would be to the last page belonging to menu item 1009 and so might be to the page “prod_kitchendesigns.htm”.

At step 5305 the content data obtained at step 4403 by removing unwanted code from the content file opened at step 4402 is inserted.

FIG. 54

FIG. 54 details step 4406 at which the page generated at step 4405 is saved. At step 5401 the page is saved to the destination directory as the value of the variable THISCATNAME, followed by an underscore, followed by the value of the variable THISPAGENAME, with the file format “htm”.

At step 5402 a question is asked as to whether the value of the variable m is one. If this question is answered in the affirmative then the page is saved again as the value of the variable THISCATNAME, with the file format “.htm”. Thus the first page in every category is saved again to provide a link for the category hyperlinks for which the code is inserted at step 4901. The extra pages saved at step 5404 cannot be reached via any “Previous Page” or “Next Page” links and are only used for the category hyperlinks.

At this point, and if the question asked at step 5402 is answered in the negative, then at step 5404 the variable PAGES_SAVED is incremented by one. At step 5405 a question is asked as to whether the value of the variable PAGES_SAVED is less than two, and if this question is answered in the affirmative then the page is saved again as “index.htm”. Thus the first page in a website is saved again to provide a homepage. It is not linked to from anywhere within the site but is provided so that links to the website from other websites available on internet 105 are not broken if the web designer changes the name of any of the pages in the website.

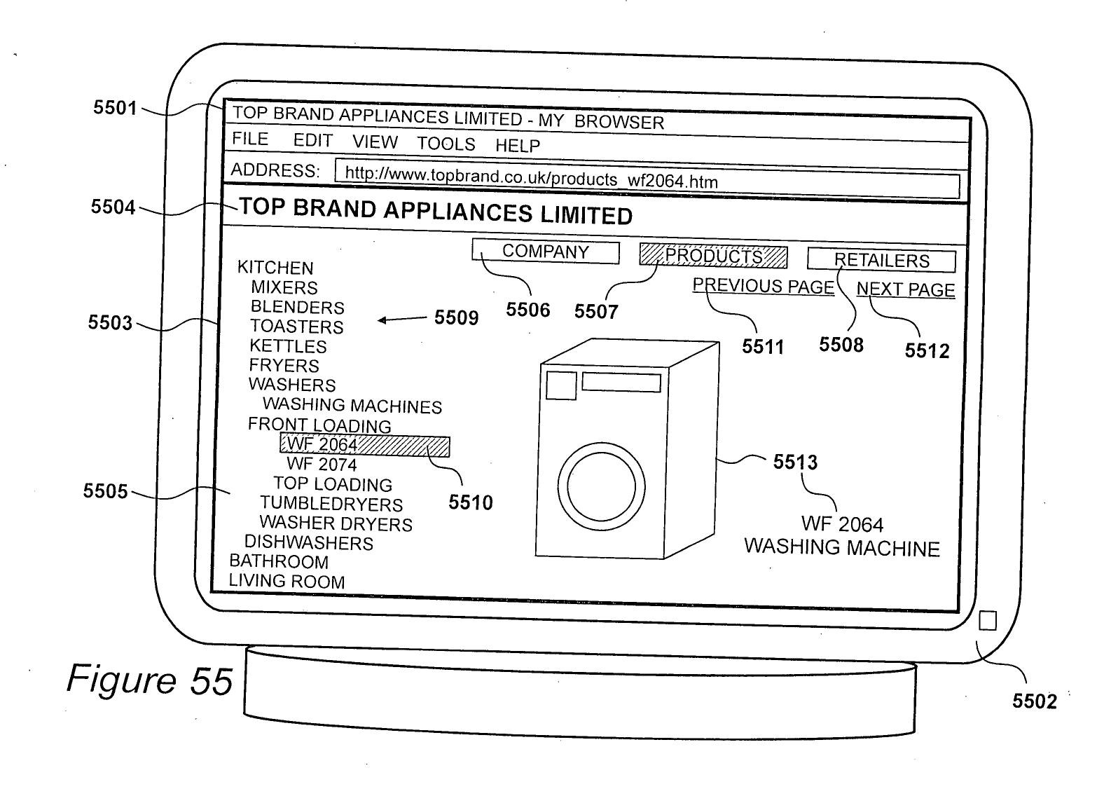

FIG. 55

FIG. 55 illustrates an example of a page within a website created using the application herein described. The pages making up the website have been uploaded to host server 106 and are being viewed using browser 5501 on a user terminal, such as user terminal 101, and displayed on VDU 5502. Thus the URL indicates the name of a website followed by the name of a page.

The browser 5501 processes the code contained in the page in order to display a viewable page 5503. Banner area 5504 is displayed using the code inserted at step 4802, while the content area 5505 is displayed using the code inserted at step 4803. It includes category hyperlinks 5506, 5507 and 5508 corresponding to categories 1001 to 1003 respectively, of which hyperlink 5507 is highlighted to indicate that the currently viewed page belongs to category 1002. It also includes partial menu structure 5509, which comprises the visible menu items for the currently viewed page. Hyperlink 5510 corresponds to menu item 1024 and is highlighted to indicate that the currently viewed page belongs to that menu item.

Hyperlink 5511 takes the user to the last page belonging to menu item 1022, while hyperlink 5512 takes the user to the next page in the sequence, which may be another belonging to menu item 1024 or the first belonging to menu item 1025.

The content area finally includes content data 5513, which in this example comprises a picture of the product and some text. However, the content area could contain any kind of media file or other content. In other embodiments it is possible that the content area could contain areas created using scripts, or even that the whole site could be dynamic but created in much the same way, by combining content data with navigation data that is stored separately and thus can be easily changed without altering the content of any page.

Thus the content area 5505, which is derived from the content data 5513, is displayed with components of the navigation structure, such as hyperlinks 5506 to 5508, 5511 and 5512, and partial menu structure 5509, within the boundary of viewable page 5503.

1. A method of generating a plurality of pages suitable for viewing over the Internet with hyperlinks interconnecting said pages, wherein each page includes a plurality of hyperlinks arranged to represent a portion of a hierarchical navigation system, comprising the steps of
storing a plurality of content files for containing content data;
creating and storing a logical and editable representation of said navigation structure in the form of navigation data; and
processing said content files in combination with said navigation data to produce a plurality of pages each representing said navigation structure, such that when displayed by a browser
a content area derived from said content data is displayed with components of said navigation structure within the boundary of a viewable page.

2. A method according to claim 1, wherein said navigation data is in the form of a database having a plurality of tables.

3. A method according to claim 2, wherein said step of creating and storing said navigation data includes the steps of repeatedly editing said database using information provided by a user via forms presented on webpages displayed on a browser.

4. A method according to claim 1, wherein said processing step comprises the steps of:
creating a dynamic page that combines elements of said navigation structure with said content data; and
caching an equivalent of said dynamic page for each of said plurality of said content files to produce said plurality of pages.

5. A method according to claim 4 wherein said navigation structure includes a menu structure, and said step of creating a dynamic page includes the steps of:
creating first data that defines an ordering for said pages;
creating second data that, for each menu item belonging to said menu structure, defines page numbers within said ordering for which said menu item is visible.

6. A method according to claim 5, wherein said first data is a string of page identifications and said step of creating said first data comprises the steps of:
creating a string of menu item identifications; and
selecting each menu item identification in turn and identifying the page identifications with which it is associated.

7. A method according to claim 6, wherein:
said string of menu item identifications is a delimited string and for each menu item, its delimiter identifies its level within said menu structure; and
when said viewable page is displayed by a browser, each menu item is displayed using a style indicated by its level.

8. A method according to claim 4, wherein for each of said plurality of pages, said step of caching an equivalent of said dynamic page comprises the steps of:
obtaining a page number,
identifying, from said second data, visible menu items for said page number;
including said identified menu items and said content data within a predefined page template.

9. Apparatus for publishing a website, comprising a processor, storage, memory, a display and a manual input, wherein said processor is configured to perform the steps of:
storing, in said storage, a plurality of content files for containing content data;
creating and editing navigation data providing a logical and editable representation of the navigation structure of said website and storing said navigation data in said storage,
processing said content files in combination with said navigation data to produce a plurality of pages each representing said navigation structure, such that when displayed by a browser
a content area derived from said content data is displayed with components of said navigation structure within the boundary of each viewable page.

10. Apparatus according to claim 9, wherein said navigation data is in the form of a database having a plurality of tables.

11. Apparatus according to claim 10, wherein said processor is additionally configured to perform the step of running an internet browser, and to edit said navigation data by repeatedly editing said database using information received from said manual input as input in forms presented on webpages displayed by said browser.

12. Apparatus according to claim 9, wherein said processor is configured to perform said processing by performing the steps of:
creating a dynamic page that combines elements of said navigation structure with said content data; and
caching an equivalent of said dynamic page for each of said plurality of said content files to produce said plurality of pages.

13. Apparatus according to claim 12 wherein said navigation structure includes a menu structure, and step of creating a dynamic page includes the steps of:
creating first data that defines an ordering for said pages;
creating second data that, for each menu item belonging to said menu structure, defines page numbers within said ordering for which said menu item is visible.

14. Apparatus according to claim 13, wherein said first data is a string of page identifications and said step of creating said first data comprises the steps of:
creating a string of menu item identifications; and
selecting each menu item identification in turn and identifying the page identifications with which it is associated.

15. Apparatus according to claim 14, wherein:
said string of menu item identifications is a delimited string and for each menu item, its delimiter identifies its level within said menu structure; and
when said viewable page is displayed by a browser, each menu item is displayed using a style indicated by its level.

16. Apparatus according to claim 12, wherein for each of said plurality of pages, said step of caching an equivalent of said dynamic page comprises the steps of:
obtaining a page number,
identifying, from said second data, visible menu items for said page number;
including said identified menu items and said content data within a predefined page template.

17. A computer-readable medium having computer-readable instructions executable by a computer thereon such that, when executing said instructions said computer will generate a plurality of pages suitable for viewing over the Internet with hyperlinks interconnecting said pages, wherein each page includes a plurality of hyperlinks arranged to represent a portion of
a hierarchical navigation system, by performing the steps of:
storing a plurality of content files for containing content data;
creating and storing a logical and editable representation of said navigation structure in the form of navigation data; and
processing said content files in combination with said navigation data to produce a plurality of pages each representing said navigation structure, such that when displayed by a browser
a content area derived from said content data is displayed with components of said navigation structure within the boundary of a viewable page.

18. A computer-readable medium according to claim 17, wherein said navigation data is in the form of a database having a plurality of tables.

19. A computer-readable medium according to claim 18, wherein said step of creating and storing said navigation data includes the steps of repeatedly editing said database using information provided by a user via forms presented on webpages displayed on a browser.

20. A computer-readable medium according to claim 17, wherein said webpages are written in a markup language with embedded scripting language.

21. A computer-readable medium according to claim 20, wherein said markup language is HTML and said scripting language is PHP.

22. A computer-readable medium according to claim 17, wherein said processing step comprises the steps of:
creating a dynamic page that combines elements of said navigation structure with said content data; and
caching an equivalent of said dynamic page for each of said plurality of said content files to produce said plurality of pages.

23. A computer-readable medium according to claim 22 wherein said navigation structure includes a menu structure, and said step of creating a dynamic page includes the steps of:
creating first data that defines an ordering for said pages;
creating second data that, for each menu item belonging to said menu structure, defines page numbers within said ordering for which said menu item is visible.

24. A computer-readable medium according to claim 23, wherein said first data is a string of page identifications and said step of creating said first data comprises the steps of:
creating a string of menu item identifications; and
selecting each menu item identification in turn and identifying the page identifications with which it is associated.

25. A computer-readable medium according to claim 24, wherein:
said string of menu item identifications is a delimited string and for each menu item, its delimiter identifies its level within said menu structure; and
when said viewable page is displayed by a browser, each menu item is displayed using a style indicated by its level.

26. A computer-readable medium according to claim 22, wherein for each of said plurality of pages, said step of caching an equivalent of said dynamic page comprises the steps of:
obtaining a page number;
identifying, from said second data, visible menu items for said page number;
including said identified menu items and said content data within a predefined page template.
